(19) United States
(12) Patent Application Publication
(10) Pub. No.: US 2025/0352966 A1
(43) Pub. Date: Nov. 20, 2025

(54) REACTORS INCLUDING SELF-CLEANING ROTATING ELEMENTS, AND ASSOCIATED SYSTEMS, DEVICES, AND METHODS

(71) Applicant: Modern Hydrogen, Inc., Woodinville, WA (US)

(72) Inventors: Fredrick Charles Davis Allan, Woodinville, WA (US); Casey Smith, Woodinville, WA (US); Shawn Lawlor, Woodinville, WA (US); Scott Edward Hogan, Mukilteo, WA (US); Daniel Kraemer, Mukilteo, WA (US); Alex J. Pearse, Bothell, WA (US); Peter Jeremy Scherpelz, Seattle, WA (US); Andrew James Ritchey, Bothell, WA (US); Patrick D. Noble, Seattle, WA (US); Sarah Whitaker, Woodinville, WA (US); Jeffery Henry, Bothell, WA (US)

(21) Appl. No.: 19/207,622

(22) Filed: May 14, 2025

Related U.S. Application Data
(60) Provisional application No. 63/647,548, filed on May 14, 2024.

(51) Int. Cl. B01J 6/00; B01J 4/00; C01B 3/24

(52) U.S. Cl. CPC B01J 6/008; B01J 4/001; C01B 3/24; C01B 2203/0272; C01B 2203/1235

(57) ABSTRACT

Embodiments include a pyrolysis reactor including a rotating element that includes a first surface, a second surface, and where, in operation: the first surface and/or the second surface is positioned to receive the solid carbon, resulting in carbon buildup on the first surface and/or the second surface, and as the rotating element rotates, the first surface and/or second surface is configured to remove at least a portion of the carbon buildup. Some embodiments include a pyrolysis system including a pyrolysis reactor, a regeneration oxidizer feed, and a mechanical removal mechanism. Some embodiments include a pyrolysis reactor including a first rotating tube that includes an outer surface, a second rotating tube including an inner surface, a pyrolysis chamber between the outer surface and the inner surface, and where rotation of the first rotating tube and the second rotating tube is configured to remove carbon buildup.

### RELATED APPLICATIONS

This application claims the benefit of U.S. Provisional Patent Application No. 63/647,548, filed May 14, 2024, the entirety of which is incorporated herein by reference.

### FIELD

This disclosure relates generally to reactors and cleaning the reactors. More particularly, the present disclosure relates to pyrolysis reactors, regenerating pyrolysis reactors, and self-cleaning rotating elements of the reactors configured to remove solid-state carbon product.

### BACKGROUND

Certain chemical reactions produce a solid carbon product or co-product from a gas or liquid precursor. An example of one such reaction is a pyrolysis reaction. In the pyrolysis reaction of hydrocarbons (e.g., natural gas, methane, propane, and/or other suitable hydrocarbons), the hydrocarbon(s) split into hydrogen gas (H₂) and solid carbon (C). As an example, methane pyrolysis splits methane into hydrogen and solid carbon (CH₄→C+2H₂). Other examples of chemical reactions that produce a solid carbon product or co-product from a gas or liquid precursor include propane pyrolysis, ethylene cracking, and dry reforming of methane, each of which can commonly encounter issues with coking and carbon buildup. Removing and clearing this solid buildup so that the chemical reactor can operate continuously without clogging is a major design challenge. The solid deposition occurs because of both the accumulation of particles generated in gas-phase reactions, as well as direct deposition reactions on hot surfaces (e.g. via chemical vapor deposition (CVD)). Accordingly, there is a need in this technology sector for systems and methods to deal with the solid deposition of carbon products or co-products.

In addition to the design challenges to continuously operate the chemical reactor without clogging, there are additional design challenges due to the nature of the chemical reactions that produce a solid carbon product or co-product from a gas or liquid precursor. For example, pyrolysis reactors can have very high operating temperatures, which can limit the types of components used in the reactor (as the components have to operate at the high operating temperature(s)) and can wear down the components and the reactor(s), making it difficult to continuously operate the reactor.

### SUMMARY

In general, this disclosure is directed to reactors and cleaning the reactors and, more particularly, to pyrolysis reactors, regenerating pyrolysis reactors, and self-cleaning rotating elements of the pyrolysis reactor configured to remove solid-state carbon product. In one example, the present disclosure includes a pyrolysis reactor configured to generate a product stream from a system feed, where the system feed includes a hydrocarbon reactant, and where the product stream includes hydrogen gas and solid carbon. The reactor can include a rotating element including a first surface. The reactor can also include a second surface spaced apart from the first surface by no more than a predetermined distance, where, in operation: the first surface and/or the second surface is positioned to receive the solid carbon, resulting in carbon buildup on the first surface and/or the second surface, and as the rotating element rotates, the first surface and/or second surface is configured to remove at least a portion of the carbon buildup.

In another example, the present disclosure includes a pyrolysis system. The pyrolysis system can include a pyrolysis reactor including a pyrolysis chamber configured to generate a product stream from a system feed, where the system feed includes a hydrocarbon reactant, and where the product stream includes hydrogen gas and solid carbon. The pyrolysis system can also include a regeneration oxidizer feed, where the pyrolysis reactor is configured to react a regeneration oxidizer with carbon buildup in the pyrolysis chamber to generate a regeneration product stream that is output from the pyrolysis reactor, and where the regeneration oxidizer feed is configured to remove a first portion of the carbon buildup through oxidation. The pyrolysis system can also include a mechanical removal mechanism, where the mechanical removal mechanism is configured to remove a second portion of the carbon buildup.

In another example, the present disclosure includes a pyrolysis reactor configured to generate a product stream from a system feed, where the system feed comprises a hydrocarbon reactant, and where the product stream comprises hydrogen gas and solid carbon. The reactor can include a first rotating tube including an outer surface. The reactor can also include a second rotating tube including an inner surface, where the first rotating tube and the second rotating tube are coaxial and non-concentric. The reactor can also include a pyrolysis chamber between the outer surface of the first rotating tube and the inner surface of the second rotating tube, where pyrolysis of the system feed is configured to occur in the pyrolysis chamber. In operation, the first rotating tube is positioned to receive the solid carbon that deposits on the outer surface and the second rotating tube is positioned to receive the solid carbon that deposits on the inner surface, resulting in carbon buildup on the outer surface and the inner surface, and rotation of the first rotating tube and the second rotating tube is configured to remove at least a portion of the carbon buildup.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic diagram of a reactor including a rotating element positioned to receive a solid-state product, according to an embodiment.

FIG. 2 is a schematic diagram of a reactor including multiple rotating elements positioned to receive a solid-state product, according to an embodiment.

FIGS. 3A-3E are schematic diagrams of rotating elements with various geometries, according to an embodiment.

FIGS. 4A-4E are schematic diagrams of cylindrical rotating elements with various geometries, according to an embodiment.

FIGS. 5A-5E are schematic diagrams of cylindrical rotating elements with various geometries within a housing, according to an embodiment.

FIGS. 6A-6B are different views of a schematic diagram of helical rotating elements, according to an embodiment.

FIG. 7 is a plot of experimental data showing a relationship of torque increasing over time during operation of a reactor, according to an embodiment.

FIGS. 8A-8B are different views of a schematic diagram of a reactor including rotating elements positioned to receive a carbon product, according to an embodiment.

FIGS. 9A and 9B are schematic diagrams of a rotating element and various heat sources relative to the rotating element, according to an embodiment.

FIG. 10 is a flow diagram of a method for removing a solid-state product produced within a reactor, according to an embodiment.

FIG. 11 is a schematic diagram of a pyrolysis system with regeneration capabilities, according to an embodiment.

FIG. 12 is a schematic diagram of a reverse flow for a pyrolysis system, according to an embodiment.

FIG. 13 is a schematic diagram of a pyrolysis system with regeneration capabilities, according to an embodiment.

FIG. 14 is a schematic diagram of a pyrolysis system with regeneration capabilities, according to an embodiment.

FIG. 15 is a schematic diagram of an external view of a pyrolysis reactor, according to an embodiment.

FIG. 16 is a schematic diagram of a simplified cross-section of the pyrolysis reactor of FIG. 15, according to an embodiment.

FIG. 17 is a simplified schematic diagram of a reactor with a two-tube arrangement, according to an embodiment.

FIG. 18 is a simplified schematic diagram of the reactor of FIG. 17 with a heat source, according to an embodiment.

FIG. 19 is a schematic diagram of an array of reactors, according to an embodiment.

FIGS. 20A and 20B are schematic diagrams of a metal end adapter assembly, according to an embodiment.

FIG. 21 is a schematic diagram of reaction loads within a region of a reactor, according to an embodiment.

FIG. 22 is a free body diagram of a counter-rotating two tube reactor, according to an embodiment.

FIG. 23 is a flow diagram of a method of removing carbon buildup from a reactor, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Pyrolysis reactors heat hydrocarbon reactants (e.g., methane, natural gas, ethane, propane, butane, pentane, gasoline, diesel, kerosene, and/or the like) to decompose them into hydrogen gas, solid carbon, and various products. For example, pyrolysis reactors can decompose the methane, ethane, propane, and other hydrocarbon components in natural gas to generate hydrogen gas. In the example of methane, the pyrolysis reaction is:

CH₄ (gas)→C (solid)+2H₂ (gas).

The hydrogen gas co-product (H₂) can then be substituted as the fuel anywhere the natural gas would have been used. For example, the hydrogen gas can be consumed by various heating units (e.g., furnaces, water heaters, water boilers, steam boilers, and/or the like), combustion engines, fuel cells and/or power generators (e.g., in a backup power generator), combined heat and power systems, cooking units (e.g., gas stoves), and/or in various other suitable uses. Additionally, or alternatively, the hydrogen can be used in various industrial processes, such as producing various ammonia-based products (e.g., ammonia fertilizers), providing process heat, and/or other chemical processing industries and/or injected back into the natural gas pipeline to partially decarbonize the natural gas in the pipeline. The carbon co-product, meanwhile, can be sequestered and/or utilized to decarbonize the consumption of the natural gas. In some embodiments, the carbon co-product is sequestered by integrating the carbon co-product into various carbon-containing products. Purely by way of example, the carbon co-product can supplement the bitumen (or other binders) in asphalt and/or other pavement products.

Pyrolysis systems can implement the pyrolysis reaction to break down hydrocarbons (e.g., natural gas, pure methane, ethane, propane, butane, and/or other suitable hydrocarbons) into hydrogen gas and solid carbon. Examples of suitable pyrolysis systems are disclosed in U.S. Non-Provisional patent application Ser. No. 17/337,326 filed Jun. 2, 2021, now issued as U.S. Pat. No. 11,897,768, U.S. Non-Provisional patent application Ser. No. 17/832,516 filed Jun. 4, 2021, now published as U.S. Patent Application Publication No. 2022/0387952, U.S. Non-Provisional patent application Ser. No. 17/503,187 filed Oct. 15, 2021, now published as U.S.

Patent Application Publication No. 2022/0120217, U.S. Non-Provisional patent application Ser. No. 17/710,810 filed Mar. 3, 2022, now published as U.S. Patent Application Publication No. 2022/0315424, U.S. Provisional Patent Application No. 63/592,904 filed Oct. 24, 2023, and U.S. Provisional Patent Application No. 63/592,906 filed Oct. 24, 2023, the entireties of each of which are incorporated herein by reference.

It is desirable to have a continuous and/or nearly continuous runtime of a pyrolysis reactor as the machine will have more up-time, which will increase the production of the product(s)—including hydrogen gas—and reduce the cost of the hydrogen produced due to the increased up-time and production. Further, as the hydrogen gas has numerous uses (discussed herein), including being recycled into the system, substituting as fuel, and more, increasing the production of hydrogen can allow for more hydrogen gas to be used in these various uses, often as a more environmentally friendly replacement to other less environmentally friendly gases (such as natural gas, as an example).

However, as previously noted, carbon product can build up over time on operating components (e.g., of the pyrolysis system(s)). For example, carbon product can build up in the pyrolysis chamber portion of the pyrolysis reactor and the pyrolysis system. Therefore, in some instances, pyrolysis reactor(s) may need to be shut down in order to remove the carbon buildup. Removing and clearing this solid buildup can result in significant operational downtime and maintenance expenses. This challenge can be particularly difficult for applications where it is desirable to lower the emissions intensity (CO₂e/kg product) of the reaction. For example, when the solid product is carbon, it can be periodically combusted with air, steam, or oxygen and liberated as carbon oxides. However, this can result in unacceptable process emissions as well as process interruption. Instead of combusting the residual carbon (i.e., the solid carbon buildup), the solid product can be physically or mechanically removed, but this is very difficult for several reasons, including that (i) the mechanical mechanism must be compatible with continuous operation and/or high temperatures (e.g., for methane pyrolysis), (ii) the mechanical mechanism must resist abrasion and wear from abrasive/reactive solid particulates in order to not require frequent replacement, and (iii) the mechanical mechanism must be constructed with tight tolerances in cases where the reactor has internal structure developed for heat transfer. As an example, pyrolysis reactors can have operating temperatures of about 1000° C., about 1250° C., 1500° C., and/or about 2000° C.

For example, using a removable mechanical mechanism (such as a rod like structure, as an example) to enter and exit a hot reaction chamber can create various challenges and issues. For instance, the removable mechanical mechanism can break tubes (within the reactor) as actuations become more intense with greater solid carbon buildup. The seals (to prevent heat and process gasses from escaping the reaction chamber while the removable mechanical mechanism enters and exits the reactor) can also fail due to not being able to withstand the high temperatures of the reactor, which can cause the reactor to be shut down for needed repairs. Therefore, it is desirable to have a carbon buildup removal mechanism that is fully internal within the reactor, so that the need for shutdowns and repairs is minimized, while also having a structure that can withstand the forces associated with mechanical carbon removal without damaging the system.

Some embodiments of the present technology attempt to mitigate the above issues from solid carbon buildup by utilizing one or more rotating elements, and in some instances the carbon co-product itself, to remove the carbon co-product from the reactor and/or the rotating element(s). In doing so, the systems and methods disclosed herein provide a removal mechanism compatible with the demanding thermal design (e.g., high temperatures and pressures) of reactors that can also protect the underlying machinery from wear. The rotating elements are a carbon buildup removal mechanism that is fully internal within the reactor, and involves carbon scraping on carbon on other rotating elements that already make up the reaction chamber within the reactor. In some cases, carbon is mechanically removed through frictional or wear mechanisms, including but not limited to adhesive wear, abrasive wear, fretting, cracking, fatiguing, chipping, or gouging. Further, by utilizing fully internal elements (i.e., the rotating elements) as a removal mechanism, heat can be retained within the reactor and additional challenges, such as the challenges of seals with a removable mechanism passing through them periodically (discussed above), can be removed/eliminated due to the fully internal nature of the rotating elements. In addition, the rotating elements can operate while the reactor is in operation, therefore removing carbon buildup without needing to shut off the reactor and/or the system. This allows for continuous operation of the reactor(s) for long periods of time without having to turn the system off to clean out reaction chambers. Some embodiments of the present technology, either alternatively or in addition to the rotating elements, utilize a regeneration oxidizer to react with the carbon product/buildup within a pyrolysis chamber of the reactor and remove a fraction of the carbon from the chamber.

In some embodiments, the systems and/or reactors discussed herein can include a rotating element comprising a first surface, and a second surface spaced apart from the first surface by no more than a predetermined distance. The second surface can be a fixed surface or an outer surface of another rotating element. In operation, the rotating element is positioned to receive the solid-state product that deposits on the first surface while the rotating element rotates. Additionally, in operation, at least a portion of the solid product is removed via interaction (e.g., scraping, rubbing, and/or the like) with the second surface or solid product built up on the second surface as the rotating element rotates.

Embodiments of the present technology can be used in various applications and industries, including any application that generates a solid-state product on an element that is desirably removed. Specific applications can include chemical or pyrolysis reactors that produce hydrogen, acetylene, or other hydrocarbon species via pyrolysis of methane, natural gas, biogas, renewable natural gas, oils, or other hydrocarbons and which also produce carbon or other solid-state material as a co-product. Other applications can include those that produce or use carbon as a primary product and/or where grinding or abrasion produces desirable properties in the resulting carbon particles. As an example, systems may use this technology to both synthesize graphite particles and spheroidize them in one step for lithium-ion battery applications. Yet further applications can include agitating or stirring a chemical reactor (e.g., plug flow reactors, fluidized bed reactors, etc.) that actively form and/or deposit solid materials (e.g., on the rotating elements therein) that can clog the reactor.

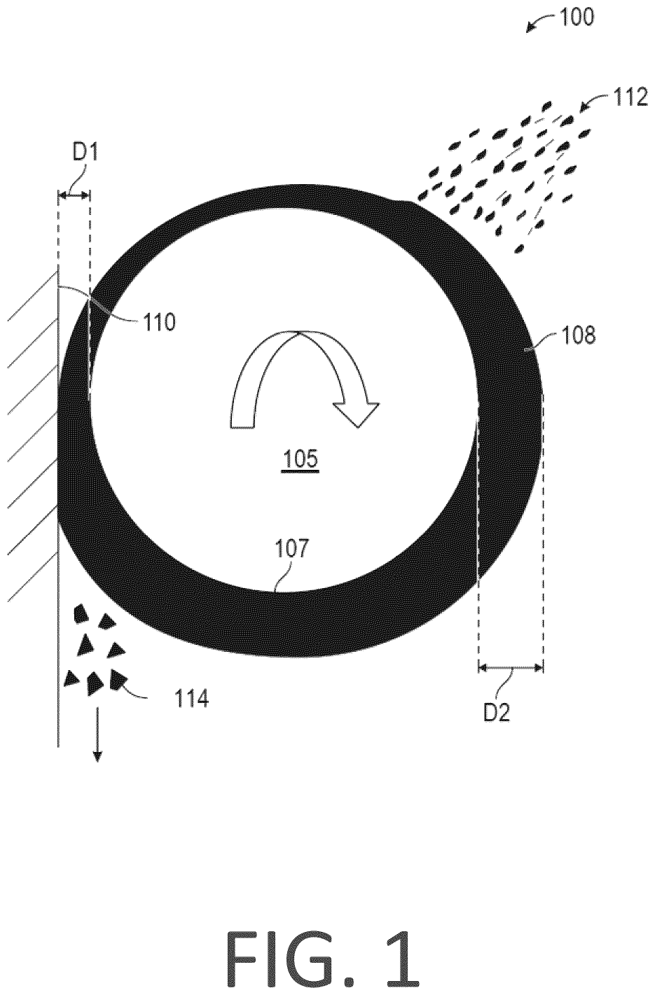

FIG. 1 is a schematic diagram of a reactor or system 100 (referred to herein as reactor 100) including a rotating element 105 positioned to receive a solid product, according to an embodiment. The reactor 100 can include any reactor that produces a solid-state product that is deposited on rotating elements of the reactor 100. Additionally or alternatively, the solid-state product can include carbon (e.g., graphitic or amorphous carbon), titanium oxide or silicon dioxide. In some embodiments, the reactor 100 can be a pyrolysis reactor and/or configured to receive a feed (e.g., hydrocarbons, methane, propane, natural gas, biogas, oils, mixtures thereof, etc.) and produce a product (e.g., hydrogen, acetylene, and/or other hydrocarbon species) in addition to the solid-state product (e.g., solid carbon) as well as other partial reaction byproducts.

As shown in FIG. 1, the reactor 100 can include a rotating element 105 having an outer surface 107 (e.g., a substrate or first surface), and a surface 110 (e.g., a second surface) spaced apart from the outer surface 107 by no more than a predetermined distance D1. For pyrolysis reactors, the rotating element 105 can be positioned in a pyrolysis and/or heating region, and can be exposed to temperatures of at least 500 degrees Celsius (° C.), 750° C., 1000° C., 1250° C., 1500° C., 2000° C., and/or within a range of 500-2000° C. (or any range therebetween) and pressures of at least 0 barg, 1 barg, 2 barg, 3 barg, 4 barg, 5 barg, 10 barg, 15 barg, and/or within a range of 0-15 barg (or any range therebetween) and/or of at least 1 bar, 2 bar, 3 bar, 4 bar, 5 bar, 10 bar, 15 bar (or any range therebetween). In some embodiments, D1 can be tailored to the type of reactor and/or primary product (e.g., hydrogen, acetylene, etc.) produced, and in some embodiments can be no more than 500 millimeters (mm), 400 mm, 300 mm, 200 mm, 100 mm, 90 mm, 80 mm, 70 mm, 60 mm, 50 mm, 40 mm, 30 mm, 20 mm, 10 mm, 5 mm, 1 mm, 0.5 mm, and/or any range therebetween (e.g., 0.5-500 mm, 13-450 mm, etc.). In some embodiments, the predetermined distance can be moveable (for example, bringing the first surface and the second surface in and out of contact with each other). The rotating element 105 can include or be coupled to other components to enable rotation, such as rotors, motors, gears, or the like, and can be configured to rotate clockwise or counterclockwise about an axis at average speeds of at least 0.1 revolutions per minute (RPM), 1 RPM, 5 RPM, 10 RPM, 100 RPM, 250 RPM, 500 RPM, 1000 RPM, and/or within a range of 1-1000 RPM (or any range therebetween). The rotating element 105 is positioned to receive the solid-state product produced via a reaction supported by the reactor 100, such that buildup 108 of the solid-state product (e.g., such as solid carbon) occurs on the outer surface 107 as the rotating element 105 rotates. The buildup 108 of the solid-state product can equal a distance D2 that is greater than D1 and that defines an effective boundary of the rotating element and solid-state product during steady-state operation. The solid-state product can be deposited (referred to herein as product deposition 112) onto the outer surface 107 via any number of processes, including but not limited to chemical vapor deposition (CVD). The deposition 112 can be uniform on the entire surface of the rotating element 105, or can be inhomogeneous and/or directional. The rotating element 105 can be positioned horizontally, vertically, or at any angle between horizontal and vertical. In some embodiments, the rotating elements 105 are hollow and are configured to receive gases or fluids used within the reactor 100 (e.g., for preheating the received gases to help improve an efficiency of the reactor 100 and/or for combusting the received gasses to provide heat to drive the chemical reaction).

The rotating element 105 can be a cylinder and/or have a circular shape as shown in FIG. 1, or any other shape disclosed herein. In some embodiments, the rotating element 105 can comprise a ceramic, metal, carbon-based material, composite material, and/or mixtures thereof. The ceramic can include silicon carbide, aluminum oxide, silicon nitride, boron nitride, aluminum nitride, zirconium oxide, mullite, titanium nitride, magnesium oxide, cordierite, all various compositions and stoichiometries thereof, and/or mixtures or coatings thereof. The metal can include tungsten, molybdenum, niobium, iron chromium aluminum alloys, steels, nickel, nickel-chromium alloys, iron-nickel-cobalt alloys, platinum, and/or mixtures or coatings thereof. Additionally or alternatively, the metal(s) can be coated with the ceramic material or the ceramic(s) can be coated with metal material. The carbon-based materials can include graphite, or composite materials designed for high temperature operation, such as carbon/carbon (C/C) or carbon/silicon carbide (C/SiC) composite materials. The rotating element 105 can also comprise other materials configured to operate at relevant reaction conditions (e.g. high temperature and high pressure) while experiencing various forces in the chemical reactor 100 and/or exhibiting chemical compatibility with the process. In some embodiments, as discussed further herein, rotating element 105 can be a rotating tube 105 within the reactor 100.

In some embodiments, the rotating element 105 can comprise a catalytic material. Advantageously, utilizing a rotating element 105 in a reactor 100 that comprises a catalytical material and/or is catalytic for the reaction can effectively remove and/or clean any solid-state material/product (such as buildup 108) that forms on the catalyst surface during operation. As such, in some embodiments, the catalyst or catalytic material remains exposed to the reactants and can continue working, which is more effective relative to other catalytic rotating elements that become coated or unexposed over time and thus become ineffective. The catalytic material can include nickel, copper, tungsten, molybdenum, rubidium, platinum, iron, manganese, zinc, tin, carbon, zeolites, vanadium, oxides, and/or mixtures thereof.

In operation, as the rotating element 105 rotates, the solid-state product buildup 108 contacts the second surface 110 to cause some of the solid-state product to be removed (e.g., scraped off), as removed product 114, from the rotating element 105 and be directed elsewhere (for example, to a collection container, etc.). In doing so, the effective boundary or amount of product buildup 108 on the outer surface 107 reduces from the distance D2 to the distance D1. In some embodiments, as discussed further herein, the second surface 110 can be another surface and/or component within the reactor, such as a second tube as an example. As more product deposits (through product deposition 112) on the outer surface 107 and as the rotating element 105 rotates and the reaction within the reactor 100 occurs, the effective boundary or amount of product buildup 108 on the outer surface 107 increases from the distance D1 to the distance D2. This buildup 108 and removal 114 of the product can continue throughout operation of the reactor 100.

Embodiments of the present technology, such as that shown in FIG. 1, have multiple advantages over related conventional technologies or mechanisms for removing a solid-state product (e.g., removed product 114) from a reactor. For example, by scraping the solid-state product off the rotating element 105 without contacting the outer surface 107 itself, the outer surface 107 is not worn down, lasts longer, and has a lower maintenance interval. Moreover, because a portion of solid-state product can remain coated over the outer surface of the rotating element, the rotating element 105 can be protected from abrasion and other mechanical wear, thereby improving operational lifecycle of the rotating element 105. Relatedly, because operation of the rotating element 105 can remove the solid-state product (i.e., removed product 114) without additional components, there can be more design space and flexibility for possible reactor geometries, relative to other methods of carbon removal. Additionally, or alternatively, because the removal mechanism for embodiments of the present technology may not be prone to clogging and may not require space for additional mechanical removal machinery, the diameter and/or cross-sectional dimensions of the rotating element 105 can be decreased, which can thereby have enhanced heat transfer. Relatedly, the smaller dimensions of the rotating element 105 can also allow any external machinery (e.g., the gears, motors, etc.) needed to drive the rotating element 105 to be more compact, thus allowing further design optionality. As another example, the buildup (e.g., buildup 108) of solid-state material on the rotating element(s) (e.g., rotating element 105) narrows the channel between the outer surface of a rotating element (e.g., outer surface 107) and an adjacent surface (e.g., second surface 110, which, in an exemplary instance, could be a surface of another rotating element). In doing so, gas flow through or around these channels has a higher velocity and/or a smaller hydraulic diameter, which can generally yield improved heat transfer between the gas and the corresponding surface and improves pyrolysis. These high aspect ratio channels can be difficult to form otherwise via machining or fabrication. As yet another example, the rotational element 105 may use only rotational seals, which are generally longer lasting than other seals (e.g., linear and/or linear and rotational seals).

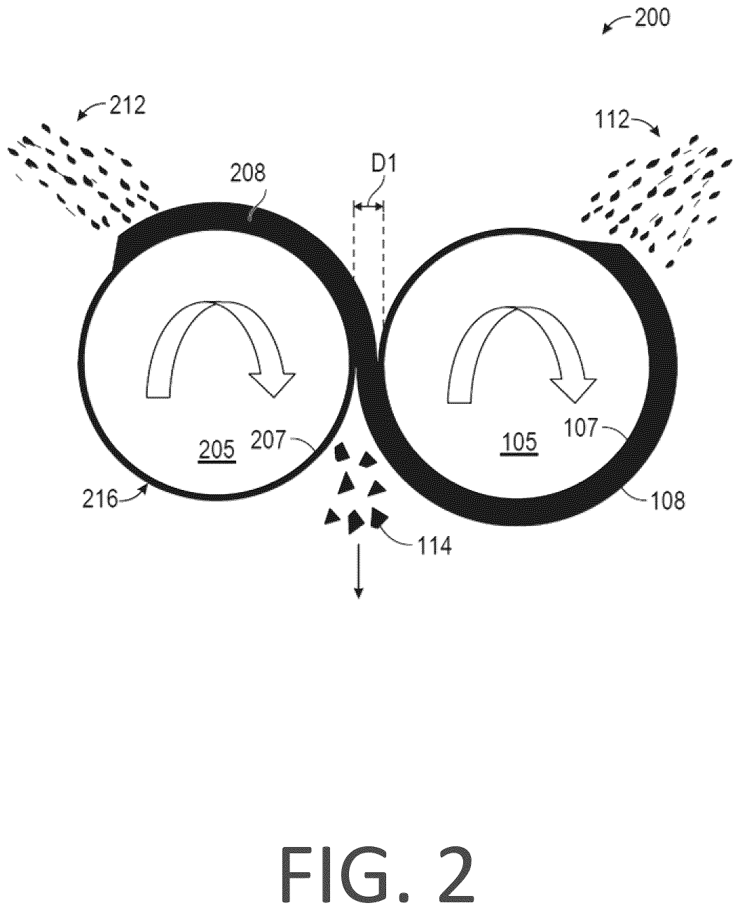

FIG. 2 is a schematic diagram of a reactor 200 including multiple rotating elements 105 and 205 positioned to receive a solid product, according to an embodiment. The reactor 200 can include all of the features and functionality described and shown with respect to the reactor 100 of FIG. 1. As depicted in FIG. 2, the reactor 200 can include the rotating element 105 and outer surface 107 positioned to receive the solid-state product/solid carbon (e.g., through product deposition 112), as described in FIG. 1. The reactor 200 can also include a second rotating element 205 including an outer surface 207 (e.g., the second surface 110 of FIG. 1) positioned to receive the solid-state product/solid carbon (e.g., through product deposition 212). The second rotating element 205 can include all of the features and functionality described and shown with respect to the reactor 100 of FIG. 1. As depicted in FIG. 2, the outer surface 107 of the rotating element 105 can be spaced apart from the outer surface 207 of the second rotating element 205 by no more than the distance D1, as previously described. In some embodiments, as shown in FIG. 2, the rotating elements 105, 205 can have the same shape and the same cross-sectional dimension. In some embodiments, the cross-sectional dimensions of the rotating elements 105, 205 can differ from one another.

In some embodiments, the reactor 200 can include more than two rotating elements (e.g., three, four, five, ten, etc.), each of which can include similar features to the other rotating elements and/or unique features different than the other rotating elements. For example, the rotating elements can have difference sizes and/or cross-sectional dimensions, different shapes, different clearances relative to an adjacent surface, and/or different rotational speeds. Additionally or alternatively, the angular velocity of the rotating elements can be non-constant. For example, periodically stopping rotation, pausing, and resuming rotating may assist in materials removal. In this regard, the design of the reactor 200, or more particularly the design of the rotating elements and their arrangement, can be based on the desired end use or application.

In operation, as the rotating elements 105, 205 rotate, the solid-state product (e.g., solid carbon) buildup 108 on the outer surface 107 contacts the solid-state product buildup 208 on the outer surface 207 to cause some of the solid-state product buildup 108, 208 over each of the outer surfaces 107, 207 to be removed (e.g., scraped off), as removed product 114, from the rotating elements 105, 205 and be directed elsewhere (e.g., to a collection container). In doing so, the effective boundary or amount of product buildup 108, 208 on the outer surfaces 107, 207 reduces. As more product (e.g., carbon) deposits 112, 212 on the outer surfaces 107, 207 as the rotating elements 105, 205 rotate and the reaction within the reactor 200 occurs, the effective boundary or amount of product buildup 108, 208 on the outer surface(s) 107, 207 increases. This buildup (e.g., product buildup 108, 208) and removal (e.g., removed product 114) of the product can continue throughout operation of the reactor 200.

The advantages described with reference to the reactor 100 also apply to the reactor 200. Additionally, because the product buildup 108, 208 for each of the rotating elements 105, 205 are the only materials that contact and cause the product to be removed, there is no wear on any fixed surface of equipment. In doing so, even less maintenance may be required and run time of the reactor 200 can be further increased.

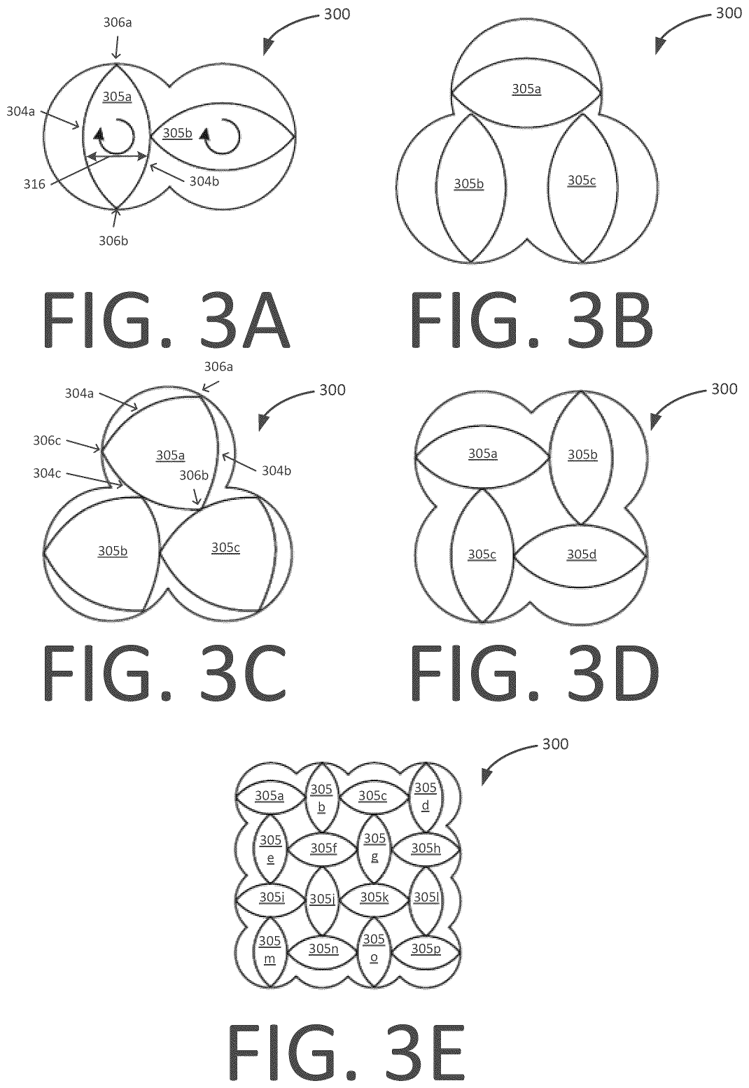

FIGS. 3A-3E are schematic cross-sectional diagrams of rotating element structures 300 with various geometries, according to some embodiments. In some embodiments, as depicted in FIGS. 3A-3E, the rotating element structures 300 can include a plurality of rotating elements 305. The rotating elements 305 and rotating element structures 300 of FIGS. 3A-3E can include any of the features and functionality described and shown with respect to the rotating elements 105, 205 of FIGS. 1 and 2. FIG. 3A includes two rotating elements 305a and 305b (referred to collectively as 305), with each rotating element 305 having a bilobed ovular shape with two curved sides 304a, 304b (referred to collectively as 304) connecting at an end point (tip) 306a, 306b (referred to collectively as 306). The tip 306 of the shape can have a width (e.g., a tip angle) including a tip angle of 0 (e.g., a point). A cross-sectional dimension 316 of the individual rotating elements decreases in a peripheral direction. As depicted, in geometries such as the rotating elements structure 300 depicted in FIG. 3A, an orientation of the rotating elements 305 can differ by approximately 90 degrees. For instance, the orientation of rotating element 305a can differ by approximately 90 degrees from the orientation of rotating element 305b, and vice versa.

FIG. 3B includes similar rotating elements 305 to that of FIG. 3A, but are trilobed with three tips arranged as three rotating elements 305a, 305b, 305c. Each rotating element 305 of FIG. 3B can have an orientation that differs from the rotating element 305 it is contacting by 90 degrees. For example, rotating element 305a can be contacting rotating element 305b and 305c, therefore rotating element 305a can have an orientation that differs from both rotating element 305b and rotating element 305c by 90 degrees. In the instance depicted in FIG. 3B, rotating elements 305b and 305c are each only contacting (or at least close to contacting) rotating element 305a, therefore rotating elements 305b and 305c can have orientations that differ from rotating element 305a by 90 degrees, but do not have to have orientations that differ from each other by 90 degrees. Therefore, as depicted in FIG. 3B, rotating elements 305b and 305c can have the same and/or similar orientations.

FIG. 3C includes three rotating elements 305a, 305b, 305c (referred to collectively as 305) that have a triangular shape, with curved sides 304a, 304b, 304c (referred to collectively as 304) connecting at end point(s) 306a, 306b, 306c (referred to collectively as 306). FIG. 3D includes four rotating elements 305a-d that have the same/similar shape as the rotating elements 305 of FIGS. 3A and 3B. FIG. 3E includes sixteen rotating elements 305a-p that have the same/similar shape as the rotating elements 305 of FIGS. 3A and 3B. Embodiments of the present technology can include any number of rotating elements (e.g., 4, 5, 6, 7, 8, 8, 10, 20, etc.) and patterns described herein, as well as any shape (e.g., bi-lobe, tri-lobe, multi-lobe, etc.). In some embodiments, the rotating shapes/elements 305 are constructed via specific geometries to create the self-cleaning effect for non-circular shapes. For example, for each number of lobes and for a given center-to-center distance, shapes can be constructed from connected circular arcs such that, during co-rotation, every point on the surface of a first element 305 is cleared by the tip of the other rotating elements 305. Additionally, or alternatively, the outer housing of the reactor can be constructed from the union of enclosing circles surrounding the array of rotating elements such that the reactor wall is also completely cleaned.

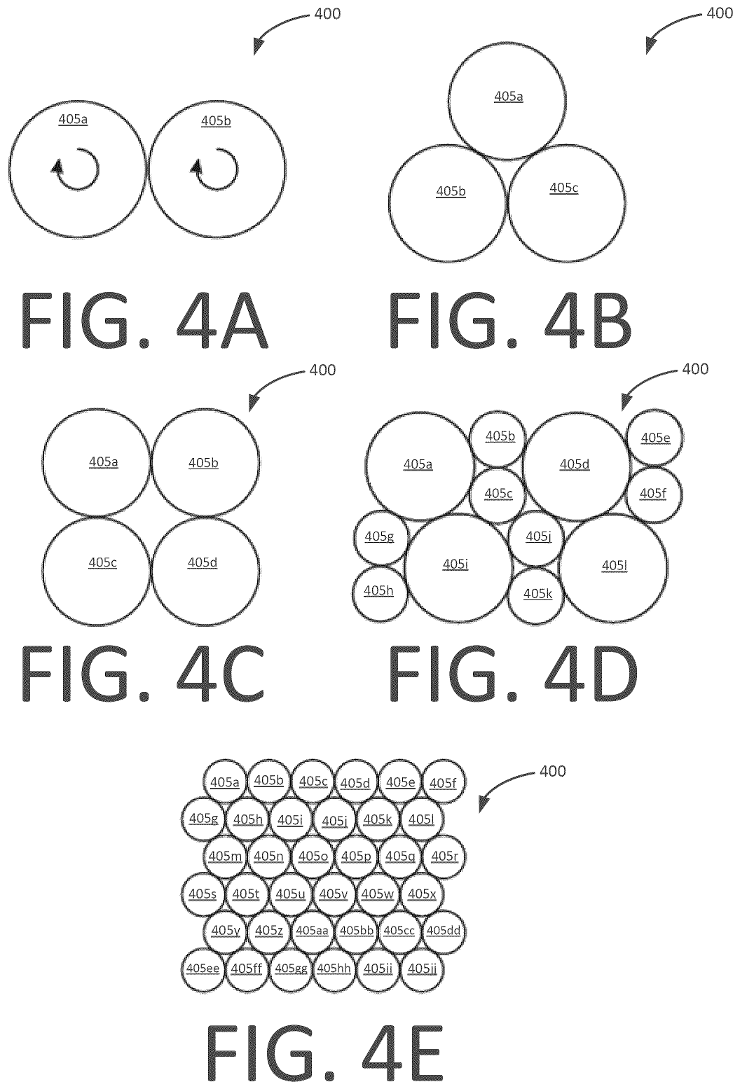

FIGS. 4A-4E illustrate schematic diagrams of rotating element structures 400 with cylindrical rotating elements 405 with various geometries, according to some embodiments. The rotating elements of FIGS. 4A-4E can include any of the features and functionality described and shown with respect to the rotating elements 105, 205 of FIGS. 1 and 2, as well as the rotating elements 305 of FIGS. 3A-3E. The rotating element structure 400 of FIG. 4A includes two cylindrical rotating elements 405a, 405b similar to those described with respect to FIG. 2. FIGS. 4B, 4C, and 4E include three (405a-c), four (405a-d), and 36 (405a-jj) cylindrical rotating elements, respectively, wherein the cross-sectional dimensions of each of the rotating elements are the same or similar.

FIG. 4D includes 12 cylindrical rotating elements 405a-1, wherein some of the rotating elements have different cross-sectional dimensions than other rotating elements. For example, FIG. 4D depicts an example structure 400 where rotating elements 405a, 405d, 405i, and 405l all have similar cross-sectional dimensions (e.g., a first cross-sectional dimension) and rotating elements 405b, 405c, 405e, 405f, 405g, 405h, 405j, and 405k all have similar cross-sectional dimensions (e.g., a second cross-sectional dimension). However, the first cross-sectional dimension and the second cross-sectional dimension can be different from each other (e.g., the first cross-sectional dimension can be bigger than the second cross-sectional dimension). Embodiments of the present technology can include any number of rotating elements 405, any pattern of rotating elements 405, and any combination of cross-sectional dimensions for the rotating elements 405.

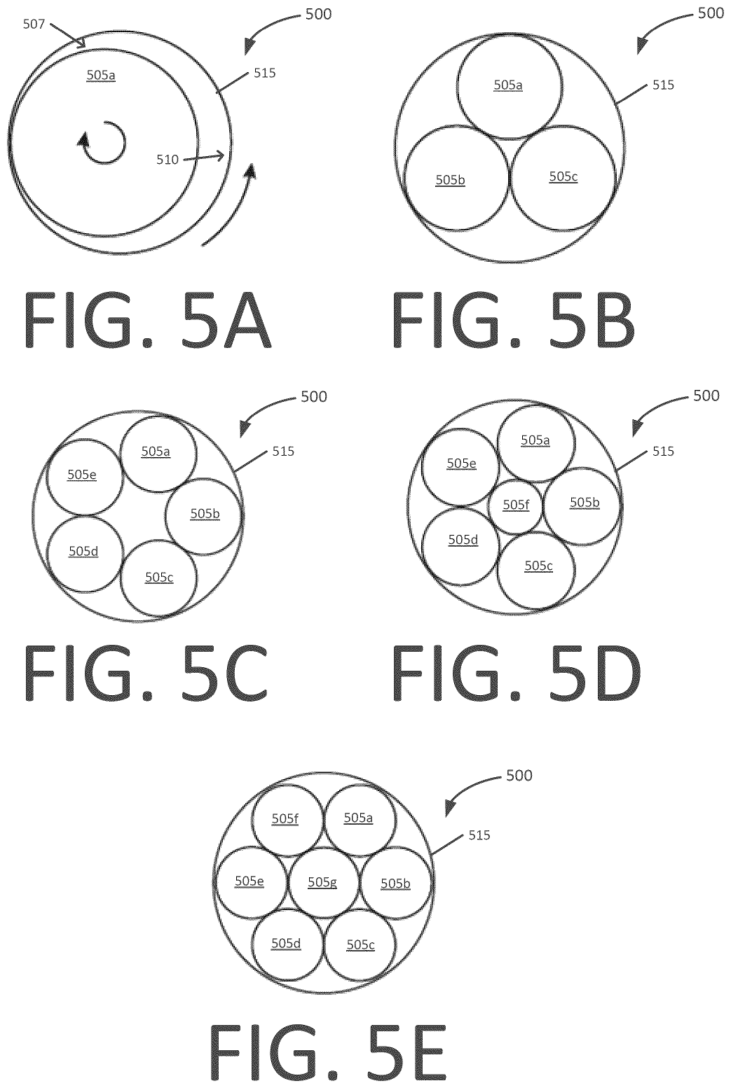

FIGS. 5A-5E illustrate schematic diagrams of rotating element structures 500 with cylindrical rotating elements 505 with various geometries within a housing 515, according to some embodiments. The rotating elements 505 of FIGS. 5A-5E can include any of the features and functionality described and shown with respect to the rotating elements 105, 205, 305, 405 of FIGS. 1-4E. The rotating element structure 500 of FIG. 5A includes a rotating element 505a having an outer surface 507, wherein the rotating element 505a is within an inner surface 510 of the chamber/housing 515. In some embodiments, as depicted in FIG. 5A, the housing 515 and its inner surface 510 can have a similar shape to the outer surface 507 of the rotating element 505a.

FIGS. 5B-5E illustrate other examples of rotating elements 505. For instance, FIG. 5B illustrates a structure 500 with three rotating elements 505a-c within housing 515; FIG. 5C illustrates a structure 500 with five rotating elements 505a-e of same/similar sizes (e.g., same/similar cross-sectional dimensions), within housing 515; FIG. 5D illustrates a structure with six rotating elements 505a-f, within housing 515, having a variety of sizes/cross-sectional dimensions (e.g., with rotating element 505f having a smaller cross-sectional dimension than rotating elements 505a-c); and FIG. 5E illustrates a structure with seven rotating elements 505a-g (e.g., of same/similar sizes and cross-sectional dimensions) within housing 515.

In some embodiments, both the inner element (i.e., rotational element(s) 505) and the inner surface 510 of the chamber/housing 515 are rotated to create relative motion between the inner rotational element(s) 505 and an outer surface. The rotational element(s) 505 and the housing 515 can be counter rotated, or co-rotated if the two angular velocities differ. In some embodiments, the inner surface 510 of the chamber/housing 515 is held fixed and the inner rotating element 505 can additionally be orbited within the outer housing 515.

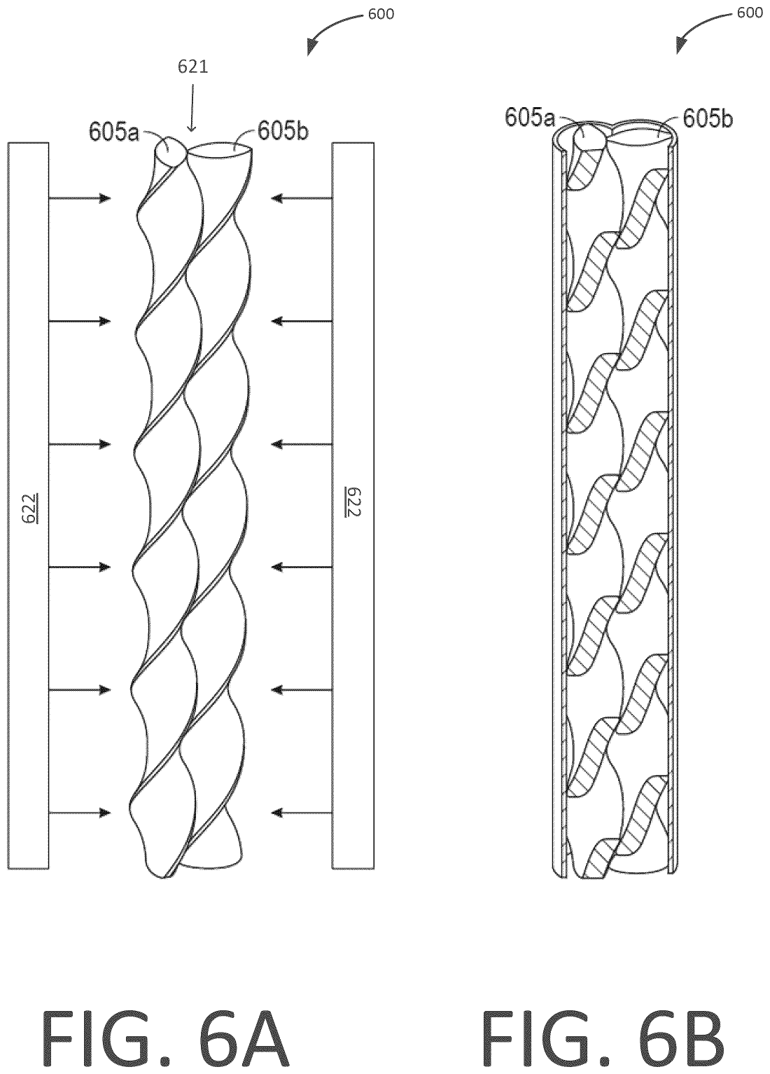

FIG. 6A is a schematic diagram of a structure 600 with twisted or helical rotating elements 605a, 605b (collectively referred to as rotating elements 605) and FIG. 6B is a cross-sectional view of the rotating elements 605 of FIG. 6A, according to some embodiments. The rotating elements 605 can include any of the features and functionality described and shown with respect to the rotating elements of FIGS. 1-5E. While the geometries of rotating elements 605 may be illustrated (in FIGS. 6A and 6B) as being a bilobed ovular shape similar to the geometries depicted in FIG. 3A, rotating elements 605 can have other geometries.

In some embodiments, the shape and/or geometry of the rotating elements 605 can generally have a greater surface area than other rotating element shapes (e.g., circular shapes), and thus can receive and subsequently remove deposited solid-state product at a higher rate. Additionally, the relative amount of interface 621 between the rotating elements 605 due to their shape and/or geometry can be greater than that of other shapes of rotating elements, which advantageously can also help remove the deposited solid-state product at a higher rate. Additionally, or alternatively, twisting the rotating elements 605 can increase the path length for gas flowing down the length of several rotating elements in contact, thus increasing heat transfer. In some embodiments, such a shape (e.g., a twisted and/or helical shape) is used when carbon deposition sources 622 (or other solid deposition sources) are positioned peripherally lateral to and/or along a length of the rotating elements 605.

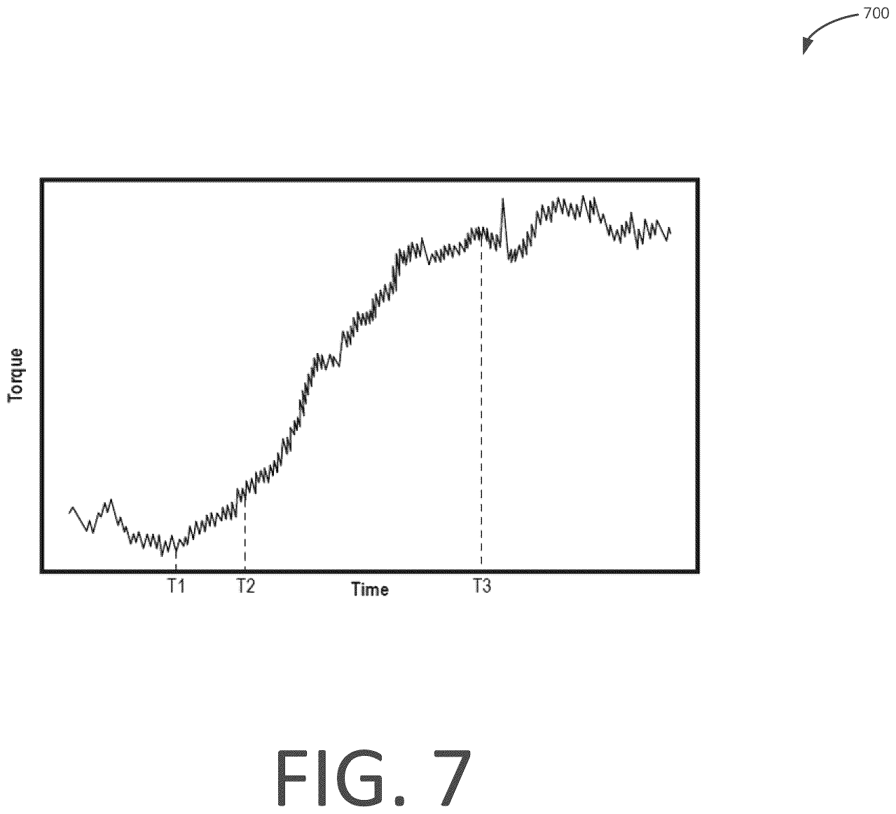

FIG. 7 is a plot 700 of experimental data showing a relationship of torque increasing over time during operation of a reactor (such as a pyrolysis reactor), according to an embodiment. The plot 700 illustrates how torque of a motor needed to turn one or more rotating elements (e.g., the rotating elements, 105, 205, 305, 405, 505, and/or 605) can change from startup of a reactor (e.g., the reactors 100, 200) to steady-state operations as solid-state product begins to build on and is removed from an outer surface of the one or more rotating elements. Time T1 corresponds generally to a startup of the reactor. As the reaction occurs within the reactor, solid-state product is produced and accumulates on the outer surface of the rotating element (for example, the same as and/or similar to product deposition 112, 212 and product buildup 108, 208 illustrated in FIG. 1 and/or FIG. 2). As the accumulation builds to a point where the accumulated product begins to contact an adjacent surface (e.g., a fixed surface, accumulated product on the fixed surface, a rotating surface, or accumulated product on the rotating surface), the torque required to turn the rotating element increases (e.g., at time T2 or any time between T1 and T3) due to the friction incurred from the accumulated product. This increase in torque continues until a maximum amount of product has accumulated on the outer surface (e.g., at time T3), at which point the torque can remain generally constant with less variation as a rate of material removal generally matches (or equals) a rate of material deposition.

Torque measurements, deflection or strain measurements of rotational elements, load and/or force measurements, product gas composition measurements, gas pressure measurements, elapsed time, and/or the like collected during operation may be used as part of a control scheme to operate the reactor. For example, measurements of torque supplied to rotary self-clearing elements may be used as an input to a control algorithm that can be used to recommend adjustments and/or automatically adjust operating parameters such as reactant gas input flowrate or composition, rate of heat delivery to the reactor, and/or temperature profile of the reactor. For example, power supplied by or the configuration of one or more burners or resistive electrical heaters may be adjusted based on torque measurement. Additionally or alternatively, a rotational speed of one or more of the rotating elements may be adjusted, the direction of rotation may be reversed, and/or the rotating may stop based on one or more of these measurements (such as the measurements discussed above, sensor feedback, time intervals, and/or other measurements).

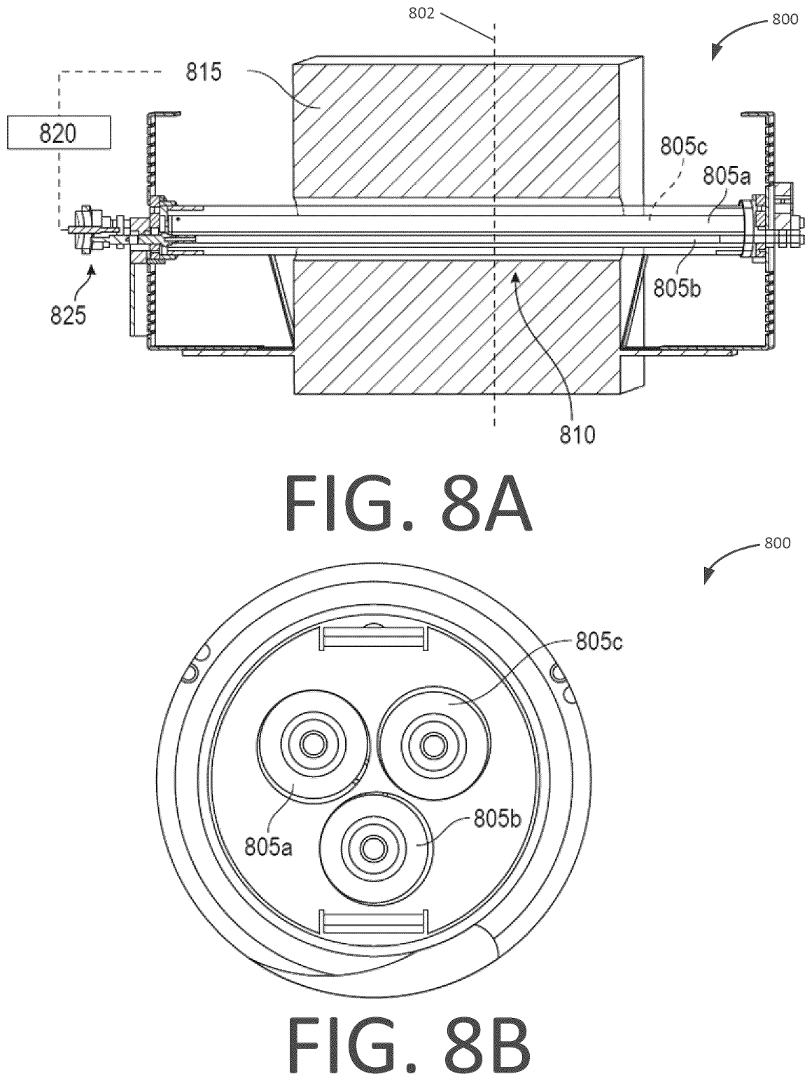

FIG. 8A illustrates a schematic diagram of a reactor 800 including rotating elements 805a, 805b, 805c (collectively referred to as rotating elements 805) positioned to receive a solid-state product (e.g., solid carbon), and FIG. 8B is a cross-sectional view (from cross-section 802) of the rotating elements 805 of FIG. 8A, according to some embodiments. The reactor 800 and/or rotating elements 805 can include any of the features described and shown with respect to the reactors 100, 200 and rotating elements 105, 205, 305, 405, 505, and/or 605, respectively, described herein.

Referring to FIG. 8A, the reactor 800 can include a heat source (such as a furnace, burner, combustion component, resistive electrical heater, and/or a device producing an electromagnetic field to deliver energy to the reactants (e.g., an induction or microwave source) as examples) 815 having a pyrolysis region 810 and/or region 810 configured to provide external heat to the rotating elements 805, a drive system 825 operably coupled to and configured to rotate the rotating elements 805, and a controller 820 operably coupled to the heat source 815 and the drive system 825. The controller 820 can be coupled to other sensors and/or various components of the reactor 800, and, in some instances, can adjust operation of the reactor 800 based on measurements from the sensors and/or components.

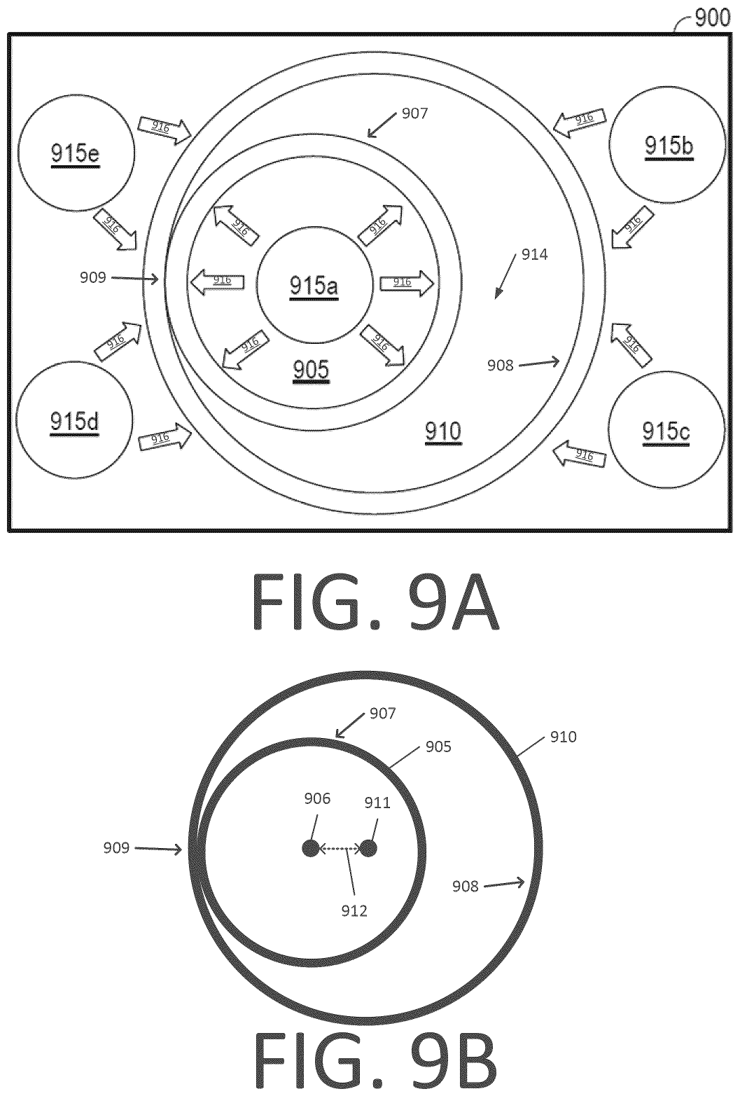

FIG. 9A is a schematic diagram of a rotating element 905 of a reactor 900, and various heat sources 915a, 915b, 915c, 915d, 915e (referred to collectively as heat sources 915) relative to the rotating element 905, according to an embodiment. FIG. 9B illustrates a schematic diagram of the rotating element 905 within a tube 910 and their corresponding centerlines/center points 906, 911. In some embodiments, the tube 910 can be a pyrolysis tube 910 and/or a pyrolysis chamber 910, and a pyrolysis reaction can occur in the passage formed between the tube 910 and the rotating element 905 (depicted as passage 914). Passage 914 can constitute a volume where the pyrolysis process and/or reaction is stabilized. In some embodiments, as depicted in FIG. 9A, passage 914 can be a crescent-shaped passage.

As illustrated in FIG. 9A, the rotating element 905 can be positioned within an outer tube or boundary wall 910 (referred to herein as tube 910). In some embodiments, the tube 910 is the same as and/or similar to housing 515 depicted in FIGS. 5A-5E. In some embodiments, as depicted in FIGS. 9A and 9B, the rotating element 905 is positioned within the tube 910 such that the centerlines and/or center points 906, 911 of the rotating element 905 and tube 910 differ (i.e., are offset 912) from one another. FIG. 9B illustrates the center point 906 of rotating element 905, the center point 911 of the tube 910, and their offset 912.

By offsetting 912 the rotating element 905 and the tube 910 (and their corresponding centerlines and/or center points 906, 911), the solid product build up on the outer diameter 907 and/or outer surface 907 of the inner rotating element 905 scrapes against the solid product build up on the inner diameter 908 and/or inner surface 908 of the outer tube 910. The scraping point, at this exemplary instance, is illustrated as scraping point 909. As the rotating element 905 and/or the tube 910 rotate, the scraping point 909 can move along the outer surface 907 and the inner surface 908. In some embodiments, the outer diameter/surface 907 of the rotating element 905 is the same as and/or similar to outer surface 107 (FIG. 1 and/or FIG. 2), outer surface 207 (FIG. 2), and/or outer surface 507 (FIGS. 5A-5E). In some embodiments, the inner diameter/surface 908 of the outer tube 910 is the same as and/or similar to second surface 110 and/or inner surface 510 (FIGS. 5A-5E). In other embodiments, the inner tube 905 is mechanically mounted such that the linear offset 912 can also be time-varied, such that carbon buildup is periodically brought in and out of grinding contact at point 909 in order to facilitate removal of carbon.

During rotation of the rotating element 905, a non-zero relative surface velocity can exist, which can be achieved by rotating both the inner rotating element 905 and the outer tube 910 (e.g., in opposite directions and/or at different relative angular velocities), or by rotating and orbiting one of the rotating element 905 or tube 910 against a stationary tube/object. These configurations are convenient for providing heat 916 from outside of the outer containing tube 910, which allows for flexibility on the size of the heat source 915 (e.g., does not need to be fit within a rotating element 905).

As shown in FIG. 9, heat 916 can be provided and/or generated within the rotating element 905 (e.g., via heat source 915a), which can include or can be a burner, combustion component, resistive electrical heater, and/or or a device producing an electromagnetic field to deliver energy to the reactants (e.g., an induction or microwave source). Heat can also be provided or generated externally to the tube 910 and rotating element 905 (e.g., via heat source 915b, 915c, 915d, and/or 915c), which can include a burner, combustion component, resistive electrical heater, and/or or a device producing an electromagnetic field to deliver energy to the reactants (e.g., an induction or microwave source). In some embodiments, when the reactor 900 includes multiple rotating elements 905 (not depicted), some of the rotating elements 905 can be heated internally (e.g., through an internal heat source 915a) while other rotating elements 905 may not be heated internally (and may not include an internal heat source 915a). Advantageously, this can reduce complexity and/or a total number of combustion sources and/or other heat sources.

In some embodiments, deposition of solid-state product (e.g., product deposition 112 and/or 212) on the rotating elements (e.g., 105, 205, 305, 405, 505, 605, 805, and/or 905) can depend on the local heat flux and/or temperature from the heat source (e.g., 915). For example, carbon deposition is often a function of temperature for pyrolysis. In such embodiments, the heat flux and temperature profile of the rotating element (e.g., 105, 205, 305, 405, 505, 605, 805, and/or 905) can be designed to control the rate of deposition of material along the length of the rotating element in order to homogenize the rate of deposition.

Additionally, the use of friction to remove solid-state product/carbon (e.g., product buildup 108 and/or 208) from the rotating element (e.g., 105, 205, 305, 405, 505, 605, 805, and/or 905) is recuperative, in that heat generation from friction can be used to offset the heat energy needing to be generated by additional heat sources. Energy used in the rotary drive system (e.g., 825) is similarly used to drive the reaction through heat generation, thereby increasing system efficiency. In some embodiments, local temperatures at regions of contact (e.g., interface 621, scraping point(s) 909, etc.) may be substantially higher than the reactor average temperature, creating a reaction “hot spot” and increasing reactor efficiency and reactant conversion. In some cases of high friction, it may be possible to supply all required reaction heat via frictional dissipation (similar to how friction stir welding works). Still further, frictional dissipation and solid product wear rates can be enhanced by adding abrasive particles into the reactor feedstock input. For example, some amount of generated carbon particles can be recirculated to the reactor.

In some embodiments, although reactor 900 is depicted as having a single rotating element 905 within an outer tube 910, there can be a plurality of rotating elements 905 within an outer tube 910. For example, rotating elements, such as rotating elements 805 (FIGS. 8A and 8B), could all be within a single outer tube, such as outer tube 910. As another example, in some instances, outer tube 910 can be the same as and/or similar to housing 515 (FIGS. 5A-5E). In this example instance, the rotating element(s) 905 could include one or more rotating elements such as the rotating elements 505 illustrated in FIGS. 5A-5E. In some embodiments, these one or more rotating elements within a housing/outer tube (such as housing 515, outer tube 910, and/or another type of outer tube) can be different quantities and/or sizes (such as rotating elements 405 illustrated in FIGS. 4A-4E) and/or different shape(s) (such as rotating elements 305 illustrated in FIGS. 3A-3E). In some embodiments, helical rotating elements (such as rotating elements 605 (FIGS. 6A-6B) can be within a single housing/outer tube (such as housing 515, outer tube 910, and/or another type of outer tube). In instances where there are a plurality of rotating elements (e.g., rotating elements 305, 405, 505, 605, 805, etc.) within an outer tube/housing, the passage(s) (such as passage 914) where a pyrolysis reaction can occur are the spaces between the plurality of rotating elements and the outer tube. In some embodiments, inside each rotating element and/or one or more of the rotating elements (e.g., rotating elements 305, 405, 505, 605, 805, 905, etc.) can be a heating element and/or combustion chamber to help produce enough heat for a pyrolysis reaction to occur in a passage/volume between the rotating elements and an outer tube/housing. In some embodiments, one or more of the rotating elements (e.g., rotating elements 305, 405, 505, 605, 805, 905, etc.) may not include a heating element and may not generate heat. For instance, heat generation within the rotating element(s) can be optional; heat can be provided from outside the housing/outer tube, from within the tube(s) and/or rotating element(s), or both.

Reactor 900 can be the same as and/or similar to reactor 1500, in some instances. For example, outer tube 910 can be the same as and/or similar to outer tube 1620 and inner tube 1610 can be the same as and/or similar to rotating element 905. Therefore, in some embodiments, although reactor 1500 is depicted and discussed herein as having a single inner tube 1610 (for example, the same as and/or similar to having a single inner rotating element 905), there can be a plurality of inner tubes 1610 and/or other shape(s), size(s), etc. of rotating elements within an outer tube (for example, outer tube 1620, discussed further herein) of a reactor (for example, reactor 1500, discussed further herein). For example, in some instances, an inner tube (such as inner tube 1610) can actually be one or more rotating elements (such as rotating element(s) 105, 205, 305, 405, 505, 605, 805, 905, etc.) within an outer tube of a reactor.

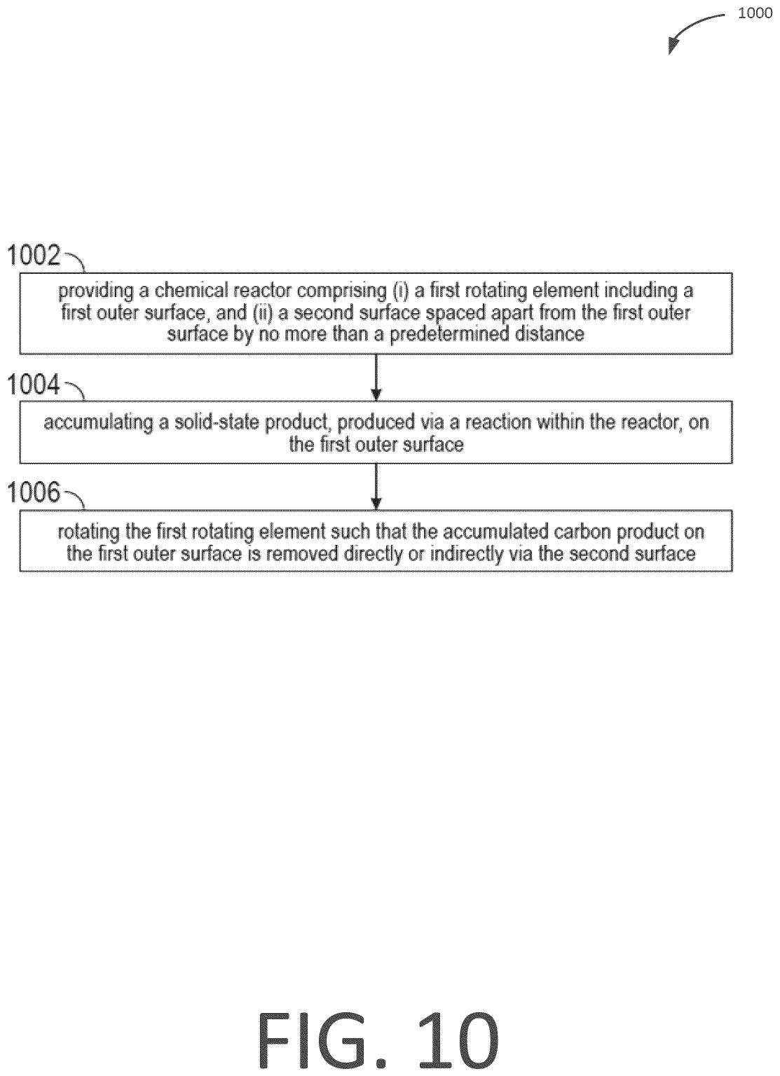

FIG. 10 is a block flow diagram of a method 1000 for removing a solid-state product produced within a reactor, according to an embodiment. The method 1000 can include an operation 1002 of providing a chemical reactor (e.g., reactor(s) 100, 200, 800, etc.) comprising a first rotating element (e.g., the rotating element 105, 305, 405, 505, 605, 805, and/or 905) including a first outer surface (e.g., the outer surface 107, 507, and/or 907), and a second surface (e.g., the surface 110, the outer surface 207, inner surface 510 of housing 515, and/or inner surface 908 of an outer tube 910) spaced apart from the first outer surface by no more than a predetermined distance (e.g., the distance D1). The method 1000 can further include operation 1004 of accumulating a solid-state product (e.g., carbon), produced via a reaction (e.g., a pyrolysis reaction) within the reactor, on the first outer surface. The method 1000 can further include operation 1006 of rotating the first rotating element such that the accumulated carbon product on the first outer surface is removed directly or indirectly via the second surface. For example, the accumulated product can be removed by the second surface itself or solid-state product (e.g., carbon) that has accumulated on the second surface.

In some embodiments, mechanical mechanisms and/or other in-situ carbon removal methods such as fluidization and/or erosion may not completely remove all carbon accumulation/buildup that impacts pyrolysis reactor operation, and thus these methods can require periodic removal of any remaining carbon deposits by completely shutting down and/or disassembling the pyrolysis reactor and/or the pyrolysis system. Further, in some embodiments, the carbon can build up faster than it can be removed. This can cause plunging cutters to stall and/or be deflected into old grooves, can cause scraping via rotation to seize up and/or cause components to fail because of the buildup. To help prevent a complete shut down and/or disassembly of the reactor, and/or to prevent carbon from building up faster than it can be removed through other removal process(es), regeneration process(es) can be utilized. Regeneration and/or regenerating, as referred to herein, can include introducing a regeneration gas to a component (such as a pyrolysis reactor and/or a pyrolysis chamber) to help regenerate (e.g., restore full functioning to) the reactor. The regeneration gas (also referred to herein as a regeneration oxidizer) can react with the carbon to help remove the carbon deposits and/or alter the carbon structural properties (which can, as an example, help loosen and/or weaken the carbon) so that the carbon can be removed using one or more other removal methods. For instance, to help remove carbon deposits (e.g., carbon buildup) from the reactor, the regeneration gas can include oxygen, which can then react with the carbon in order to oxidize the carbon and remove it from the reactor, or alter carbon structural properties in order to enhance removal by methods discussed herein (e.g., rotating element(s), other mechanical removal methods, fluidization, erosion, and/or any other removal method).

As a non-limiting example, carbon buildup can be removed by first regenerating the reactor to alter structural properties of the carbon (thus making it easier to remove) and then using the rotating elements (e.g., 105, 205, 305, 405, 505, 605, 805, and/or 905) to mechanically remove the carbon buildup. In another example, the carbon buildup can be removed solely by regenerating the reactor or by using the rotating elements discussed herein (e.g., 105, 205, 305, 405, 505, 605, 805, and/or 905). In yet another example, the carbon buildup can be removed by regenerating the reactor and then performing another carbon removal operation to remove any remaining carbon. In yet another example, the carbon buildup can be removed by performing an alternative operation to alter structural properties of the carbon and/or make the carbon easier to remove, and then by using the rotating elements (e.g., 105, 205, 305, 405, 505, 605, 805, and/or 905) to remove the carbon buildup (or at least any remaining carbon buildup).

In some embodiments, a reactor (such as a pyrolysis reactor) can have a pyrolysis mode and a regeneration mode. In a pyrolysis mode, the system (containing the pyrolysis reactor) can flow a system feed into the reactor. The system feed can be hydrocarbon reactant(s) (e.g., methane, natural gas, ethane, propane, butane, pentane, gasoline, diesel, kerosene, and/or the like) in some instances, such that when fed into the pyrolysis reactor during pyrolysis mode, the pyrolysis reactor can heat the system feed to decompose it into hydrogen gas, solid carbon, and various products. During a regeneration mode, the system can flow/feed a regeneration oxidizer into the reactor to allow the regeneration oxidizer to react with the carbon product/buildup within the reactor.

In some instances, the regeneration reaction (i.e., the reaction of the regeneration oxidizer and the carbon buildup) may not uniformly etch carbon away and/or remove the carbon, but instead may pit certain areas more than others, creating a roughened, more porous, surface within the reactor and/or mechanically weakening the entire carbon buildup/deposit. Therefore, in some embodiments, the regeneration mode may be most effective in combination with another removal process (such as the removal process(es) discussed herein). For instance, one the regeneration mode has roughened and/or weakened the carbon buildup, a carbon removal method (such as plunging a cutter into the carbon, scraping the carbon against another surface (such as rotating element(s)), and/or any other carbon removal method) has the potential to more effectively remove carbon buildup (compared to either the regeneration mode or the carbon removal method on their own).

For instance, the regeneration process/mode may occur for a relatively short, limited duration-much shorter than required to remove all the carbon. This allows the regeneration mode to run for enough time to change the carbon structural properties, without fully removing the carbon, so that the carbon can be more easily removed using another carbon removal method. This can help prevent excess emissions of carbon monoxide and/or carbon dioxide, as running regeneration for a relatively short, limited duration emits much less carbon monoxide and/or carbon dioxide than removing the carbon entirely through regeneration would. Therefore, removing carbon buildup from a reactor using a combination of regeneration and another removal process can reduce emissions and can be a more environmentally-friendly process. Additionally, the regeneration process can happen for a shorter duration (as it does not need to remove as much carbon), which allows for less time to be spent on regeneration and more time spent running the desired reaction in the reactor. For example, a pyrolysis reactor may have to pause pyrolysis (e.g., hydrocarbon pyrolysis) while the reactor is being regenerated. However, various other carbon removal processes (such as the rotating element(s) discussed herein and/or other carbon removal process(es)) can be executed while the reactor is running pyrolysis. By only running regeneration for enough time to alter carbon structural properties (but not long enough to fully remove the carbon from the reactor), the reactor can pause pyrolysis reaction(s) for a shorter amount of time, allowing for more continuous pyrolysis and more continuous hydrogen gas generation.

Another possible removal process, either alternative to or in addition to regeneration, can include cooling and/or heating up the carbon beyond its standard pyrolysis temperature, and then returning it to its standard pyrolysis temperature. This will cause the carbon buildup to expand and/or contract relative to the surface it is adhered to, due to the different thermal expansion of different materials. This can cause cracking and/or other deformation of the carbon, also enhancing removal. In some instances, the reactor can be cooled relative to the nominal operating conditions to achieve the same effect. In an exemplary embodiment, the cooling and/or heating of the carbon beyond its standard pyrolysis temperature can be combined with regeneration and/or a mechanical removal process (such as the rotating element(s)) in order to help improve carbon buildup removal within the reactor.

In some embodiments, the regeneration oxidizer (i.e., the regeneration gas containing oxygen that can react with the carbon buildup within the reactor) is an oxygen-containing component such as air, oxygen, steam, carbon dioxide, and/or another regeneration oxidizer. When the regeneration oxidizer is oxygen and/or air, the regeneration reaction can include:

2C (solid)+O₂ (gas)→2CO (gas)

When the regeneration oxidizer is steam, the regeneration reaction can include:

C (solid)+H₂O (gas)→H₂ (gas)+CO (gas)

When the regeneration oxidizer is carbon dioxide, the regeneration reaction can include:

C (solid)+CO₂ (gas)→2CO (gas)

While the regeneration oxidizers and regeneration reactions are beneficial in helping remove carbon buildup, the process of using oxidative chemistry in combination with carbon can generate some carbon monoxide and/or carbon dioxide in the regeneration product (also referred to herein as regeneration exhaust), as shown by the example reactions above. As one of the advantages of hydrocarbon pyrolysis is low carbon dioxide emissions relative to other methods of hydrogen and carbon production, mitigating these emissions is important. At the high temperatures of methane pyrolysis, the primary regeneration product (from the regeneration reaction between the regeneration oxidizer(s) and carbon) is carbon monoxide, as shown by the example reactions above. In some instances, to help remove carbon from the carbon monoxide regeneration product, the reaction can be reversed in a separate process step. For example, when the regeneration oxidizer is carbon dioxide, the regeneration reaction can be reversed in a separate process step (for example, the Boudouard reaction) to remove up to half of the carbon in the carbon monoxide regeneration product/exhaust. The reversed/reversible reaction can include:

2CO (gas)+↔CO₂ (gas)+C (solid)

In some instances, it may be possible to implement enhanced oxidation regeneration without any additional system carbon dioxide emissions if carbon dioxide is used as the regeneration oxidizer, because the regeneration reaction when carbon dioxide is the oxidizer and the reversed reaction are completely symmetric. In these instances, carbon can be gasified from the reactor, re-deposited in a different location within the system (for example, where it is easier to remove), and the resulting carbon dioxide can be stored before the regeneration process is repeated.

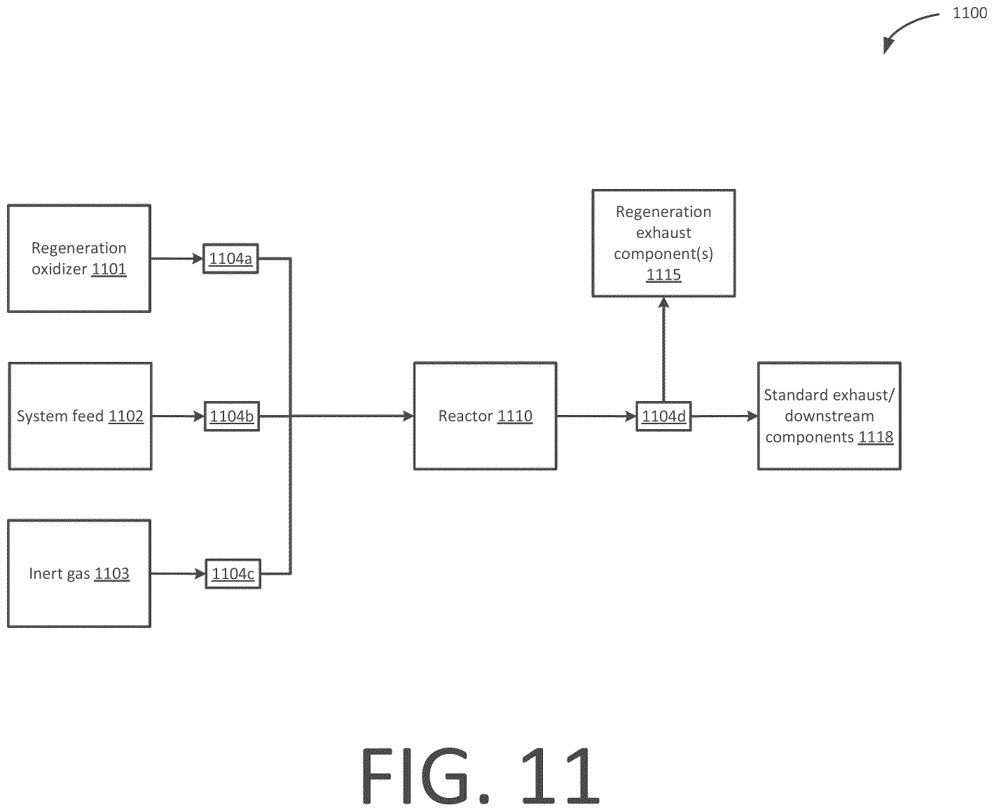

FIG. 11 illustrates an example pyrolysis system 1100 with regeneration capabilities, according to an embodiment. Pyrolysis system 1100 includes reactor 1110 (e.g., pyrolysis reactor 1110). In some embodiments, during typical operation of the reactor 1110, a system feed 1102 can be fed into the heated reactor 1110. For instance, the system feed 1102 can be hydrocarbon reactant(s) (e.g., methane, natural gas, ethane, propane, butane, pentane, gasoline, diesel, kerosene, and/or the like), and when fed into the reactor 1110, the pyrolysis reactor 1110 can heat the system feed 1102 to decompose it into hydrogen gas, solid carbon, and various products. The resulting product stream (containing at least the hydrogen gas and solid carbon) can be fed into standard exhaust component(s) 1118 and/or downstream component(s) 1118, in some instances. For example, in some instances, the product stream output from the reactor 1110 can be transmitted to separator(s) in order to separate the product stream components (e.g., separate the carbon from the hydrogen gas, separate other byproducts from the product stream, etc.), transmitted to heat exchanger(s) in order to cool and/or heat the product stream, and/or any other component(s), endpoints, etc. These product(s)/product stream from pyrolysis can be referred to herein as standard product(s), as these are the product(s) that are generated by the reactor 1110 during standard operation(s) (i.e., pyrolysis).

When pyrolysis reaction(s) are being performed within the reactor 1110, the reactor 1110 can be in a pyrolysis mode. As discussed herein, pyrolysis of system feed 1102 (containing hydrocarbon(s), for example) can result in a product stream containing hydrogen gas and solid carbon. However, over time, the solid carbon can accumulate within the reactor 1110 (for example, along the sidewalls and/or anywhere else in the reactor 1110) and can negatively impact the reactor 1110 performance and/or functioning (for example, possibly even clogging various region(s) of the reactor 1110). Therefore, instead of operating system 1100 operating continuously in pyrolysis mode, as can be a standard operation of system 1100, the system feed 1102 can be paused (thus pausing pyrolysis mode of the system 1100 and the reactor 1110). Although it can be continuous, always operating the system 1100 in pyrolysis mode can result in shorter runs, and the system 1100/reactor 1110 would need to be periodically stopped and/or shut down to clean out the system 1100 or replace the coked tubes with clean ones. Therefore, in some embodiments, to help remove the carbon buildup and/or to help alter carbon structural properties so that the carbon buildup can be more effectively removed using other means (for example, rotating elements (discussed herein), other mechanical removal mechanisms, other carbon removal methods, etc.), a regeneration technique/operation can be used.

In some embodiments, to regenerate the reactor 1110 (referred to herein as a regeneration mode of the reactor 1110), a regeneration oxidizer 1101 (e.g., air, oxygen, steam, carbon dioxide, and/or another oxygen-containing compound) can be fed into the reactor 1110 in order to react with any carbon buildup (from the pyrolysis reaction(s) of the system feed 1102). When the solid carbon is reacted with the regeneration oxidizer 1101 (and the oxygen within the regeneration oxidizer 1101) at elevated temperature(s), the resulting carbon monoxide and/or carbon dioxide product (referred to herein as regeneration product(s) and/or regeneration exhaust) can flow out of the reactor 1110 in the vapor phase. In some instances, while some carbon may be removed out of the reactor 1110 through the regeneration product(s) (i.e., as carbon dioxide, carbon monoxide, etc.), the carbon buildup may not be removed uniformly and/or entirely. Instead, in these instances, the carbon may exhibit pitting, etching, cracking, other surface features, and/or other altered structural properties, in order to weaken the solid carbon buildup formed in the reactor 1110. The flow patterns, rates, pressures, temperatures, and/or other flow characteristics may be tuned, in some instances, to maximize this effect and/or remove carbon preferentially in certain areas where it builds up the most. In some instances, the temperature of the reactor 1110 can also be tuned to help further maximize this effect. As an example, it may be beneficial to drop the temperature such that any gasification reactions (e.g., regeneration reactions) are selective to etching deep pores into the carbon buildup and increasing its roughness. The thermal profile of the reactor 1110 and/or gas flow rates may also be modified, in some instances, to target specific zones/locations for a maximum rate of carbon removal. During and/or after regeneration, mechanical removal means (such as rotating element(s) and/or other mechanical removal mechanisms), or other carbon removal methods, can be used to remove some or all of these weakened carbon solids (i.e., carbon buildup).

In some embodiments, the regeneration product(s) can be fed/transmitted from the reactor to regeneration exhaust component(s)/equipment 1115. Regeneration exhaust component(s)/equipment 1115 can include a vent to the atmosphere, combustion equipment, other treatment/processing equipment, and/or other components/equipment corresponding to the regeneration exhaust. As an example, the regeneration product(s) can be combusted in a dedicated and/or shared vapor combustor, flare, or thermal oxidizer; can be vented directly to the atmosphere; etc. In some embodiments, prior to atmosphere venting, the regeneration product(s) can undergo treatment to reduce concentration of the oxygen, carbon monoxide, carbon dioxide, nitrogen, hydrocarbon species (e.g., methane, ethane, ethylene, etc.), and/or trace contaminants such as oxides of nitrogen. Treatment devices can include a dust filter, solid adsorbent bed, controlled combustion, catalyst bed, selective catalytic reduction (SCR), wet scrubber with or without selective chemical adsorbents, electrostatic precipitator, etc. The regeneration product(s) after required treatment(s) can be combined with other pyrolysis product streams in a single vent stack, in some embodiments. Vent stack location, including orientation and elevation, can be selected to comply with applicable standards, safety, industrial hygiene, environmental regulations, and/or good engineering practices. In some embodiments, the regeneration product(s)/exhaust can be fed/transmitted out of the reactor to standard exhaust/downstream component(s) 1118. In these instances, the system 1100 may or may not include regeneration exhaust component(s) 1115.

In some embodiments (not depicted in FIG. 11), the pyrolysis/standard product(s) and/or the regeneration product(s) can be recycled back into the system 1100, carbon oxides may be captured for sequestration, or the regeneration gas can be sent to another facility (e.g., when it is syngas from steam regeneration). For example, the pyrolysis product(s) can be fed back into the reactor 1110, fed into other components of the reactor 1110 and/or the system 1100, used to power component(s) of the system 1100, and/or other use(s) for the pyrolysis product(s) within the system. Similarly, in some instances, the regeneration product(s) can be recycled into the pyrolysis process, the pyrolysis reactor 1110, and/or the pyrolysis system 1100 for further use.

In some embodiments, regeneration within a reactor 1110 can result in an oxidizing atmosphere within the reactor 1110 and/or the system 1100, as the regeneration gas 1101 (i.e., regeneration oxidizer 1101) contains oxygen. However, if any of the regeneration oxidizer 1101 were to mix with the system feed 1102 within the reactor 1110 it could be explosive, as a combustible gas (i.e., the system feed 1102) above its autoignition temperature (due to the high temperature of pyrolysis) would be mixing with an oxidizing atmosphere (due to the regeneration oxidizer 1101). Therefore, it is desirable to keep the regeneration oxidizer 1101 and the system feed 1102 separate and to prevent them from mixing in the reactor 1110, especially at high temperatures. After regeneration, the system 1100 can return to a pyrolysis mode.

To help remove oxygen, oxygen-containing compounds, and/or flammable gas from the reactor 1110, the system 1100 can, in some instances, include an inert gas flow 1103. For example, in some instances, after the system feed 1102 has been paused, the system 1100 can feed inert gas 1103 through the reactor 1110 and, in some instances downstream components 1118, in order to remove flammable gas (e.g., system feed 1102, hydrogen gas, byproducts, etc.) from the reactor 1110 and/or downstream equipment/components 1118. Similarly, in some instances, after the regeneration oxidizer 1101 has been paused (i.e., regeneration mode has been paused/stopped), inert gas 1103 can be fed through the reactor 1110 in order to remove oxygen and/or oxygen-containing compounds (e.g., regeneration oxidizer 1101, regeneration product(s), etc.) from the reactor 1110. This helps prevent explosive mixture(s) in the reactor 1110 and/or the system 1100. The inert gas flow 1103 may not always be necessary, and can be avoided if the operation(s) are designed to avoid flammable conditions. Therefore, system 1100 may not include an inert gas flow 1103, in some instances. For example, when steam is used as the regeneration oxidizer 1101, an inert gas flow 1103 may not be needed before starting the regeneration process/mode (i.e., after the system feed 1102 has been paused). Instead, steam can be directly fed/injected into the reactor 1110. The steam can react with residual system feed 1102 gas that has not yet converted to hydrogen gas (for example, through a high temperature steam methane reformer process and/or another applicable steam reaction) and can also react with the high temperature carbon buildup that has been deposited in the reactor 1110 (e.g., on a tube in the reactor 1110). These reactions can primarily form carbon monoxide and hydrogen gas along with some residual hydrocarbons and carbon dioxide, resulting in a syngas stream—a potential carbon dioxide free product stream.

In some embodiments, for example when the inert gas flow 1103 is fed through the reactor 1110 after the system feed 1102 has been paused, the inert gas flow outlet (also referred to herein as an inert gas purge, as it can include the inert gas 1103 as well as any other gases purged from the reactor 1110) can be transmitted/fed to the standard exhaust/downstream components 1118. In some embodiments, for example when the inert gas flow 1103 is fed through the reactor 1110 after the regeneration oxidizer 1101 has been paused, the inert gas purge can be transmitted/fed to the regeneration exhaust component(s) 1115. In some embodiments, the inert gas purge can have a separate outlet component and/or endpoint.

To help control the various flows through the system 1100 and the reactor 1110, the system 1100 can include various valves 1104, in some instances. In an exemplary instance, system 1100 can include valve 1104a to control flow of the regeneration oxidizer 1101 to the reactor 1110, valve 1104b to control flow of the system feed 1102 to the reactor 1110, and/or valve 1104c to control flow of the inert gas 1103 to the reactor 1110. For example, when the system 1100 is in a pyrolysis mode, valve 1104a may be closed (stopping/preventing flow of regeneration oxidizer 1101 to the reactor 1110), valve 1104b may be open (allowing flow of the system feed 1102 to the reactor 1110), and valve 1104c may be closed (stopping/preventing flow of inert gas 1103 to the reactor 1110). As another example, when the system 1100 is in a regeneration mode, valve 1104a may be open (allowing flow of regeneration oxidizer 1101 to the reactor 1110), valve 1104b may be closed (stopping/preventing flow of the system feed 1102 to the reactor 1110), and valve 1104c may be closed (stopping/preventing flow of inert gas 1103 to the reactor 1110). As yet another example, when the system 1100 is executing an inert gas purge, valve 1104a may be closed (stopping/preventing flow of regeneration oxidizer 1101 to the reactor 1110), valve 1104b may be closed (stopping/preventing flow of the system feed 1102 to the reactor 1110), and valve 1104c may be open (allowing flow of inert gas 1103 to the reactor 1110). As yet another example, in instances where the system 1100 is undergoing a mechanical carbon removal (for example, using the rotating elements discussed herein and/or another mechanical removal method), the system 1100 can also be in pyrolysis mode, and the valves 1104a-c can be in the same/similar position(s) discussed herein to allow for system feed 1102 flow through the reactor 1110. As discussed herein, pyrolysis may not need to be paused/stopped for mechanical carbon removal. In some embodiments, as an example, system 1100 can include valve 1104d to control flow from the reactor 1110 to the regeneration exhaust component(s) 1115 and/or the standard exhaust/downstream components 1118.

The valves 1104 illustrated in FIG. 11 are intended to be exemplary, and the quantity and/or location(s)/placement(s) of these valves 1104 can vary. For example, in some instances, system 1100 may have different quantities and/or locations of valves 1104. In some instances, system 1100 may not include valves 1104 and may have different components for controlling flow(s) through the reactor (as a non-limiting example, separate feeds (e.g., including inlets and/or outlets from the reactor 1110) for each inlet (1101, 1102, 1103) to help avoid cross-over. In some instances, one or more of the valves 1104 may include a plurality of valves 1104 at that location (and/or a similar location).

In some embodiments, system 1100 and/or any of the other systems discussed herein (for example, including system(s) 1300, 1400, etc.) can include a controller that can be in communication with one or more components of the system 1100.

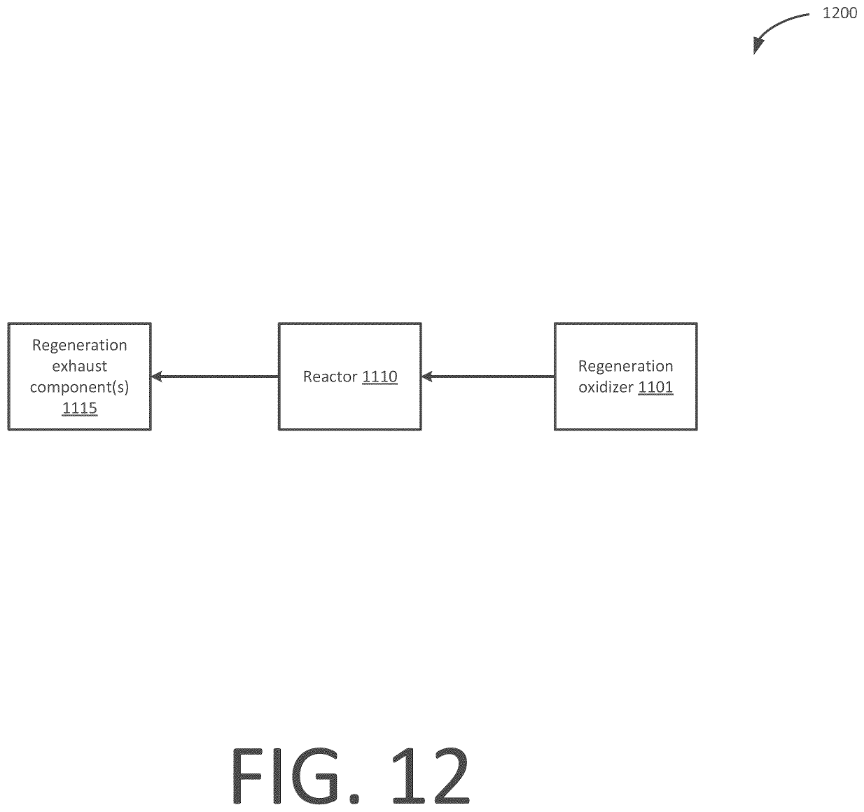

FIG. 12 illustrates a schematic diagram of a reverse direction flow 1200 for a pyrolysis system (such as pyrolysis system 1100, for example), according to an embodiment. In some embodiments, the regeneration mode/phase can be modified by flowing in the reverse direction of the standard reactor/system flow (depicted in FIG. 11). The reverse direction flow 1200 can, in some instances, flow from right to left (the reverse direction of the left to right flow illustrated in FIG. 11) and can feed regeneration oxidizer 1101 into the reactor 1110, and can feed the regeneration product(s)/exhaust from the reactor 1110 to the regeneration exhaust component(s) 1115. Although FIG. 12 depicts regeneration exhaust component(s) 1115, the regeneration product(s) can instead be fed/transmitted to the standard exhaust/downstream component(s) 1118, in some instances.

Another alternative to modify the regeneration phase is to use separate ports for the regeneration oxidizer 1101 flow and/or the regeneration product flow (e.g., to the regeneration exhaust components 1115 and/or other components) that are not shared with the standard flow ports for the standard pyrolysis flow(s) (e.g., system feed 1102 inlet, product stream outlet, and/or the like). In some instances, the regeneration oxidizer 1101 flow/path can change direction during the regeneration phase/mode (so that the oxidizer 1101 flows, for example, in the forward direction first, and subsequently in the backward direction), or may flow in different directions in subsequent regeneration phases/modes after the cycle repeats. The backward flow direction may be the direction depicted in FIG. 12, in some instances. The gas flow rate and regeneration duration can be varied, in some instances, to achieve optimal regeneration profiles. For instance, every once in a while, the regeneration duration could be long enough to remove all residual/difficult to remove carbon buildup.

The duration of each regeneration phase can be determined in various ways. For example, a set period of time could be used, or a set total volumetric flow and/or mass flow, before continuing to the next phase (e.g., an inert gas mode (for an inert gas purge), pyrolysis mode, etc.). As another example, sensor(s) of the exhaust flow(s) out of the reactor 1100 (for example, flowing to component(s) 1115, 1118, and/or other components) could be used to determine when to continue to the next phase/mode. As yet another example, sensor(s) on and/or inside the reactor 1100 could be used to determine the volume, mass, location, hardness, and/or another property of the solid carbon buildup, and use the determined property/properties to determine when to continue to the next phase/mode. These sensor(s) can include deflection sensor(s), torque sensor(s), load sensor(s), and/or other sensor(s). As yet another example, carbon dioxide and/or carbon monoxide emissions can be calculated from the regeneration phase, and a limit on the emissions can be used to determine when to stop regeneration (e.g., when to stop feeding regeneration oxidizer 1101 into the reactor 1110). As yet another example, temperature sensor(s) could be used to determine when regeneration has started, when to change the flow of regeneration gases to control the process, and/or when regeneration is complete. Any of these examples alone and/or in combination can be used to help determine a duration of each regeneration phase/mode of the reactor 1110. For example, a minimum period/duration of the regeneration mode can be determined and/or predetermined, and the duration can continue even longer if sensor readings indicate that it should.

In some embodiments, a thermal cycle could be used instead of, or in addition to, the regeneration cycle. In one such embodiment, based on a fixed period of time, some measurement of the pyrolysis product stream flow and/or some measurement on and/or inside the reactor 1110 could trigger the start of heating or cooling the reactor 1110. During this thermal cycle, a system feed 1102 could continue, an inert gas flow 1103 could be used (i.e., fed through the reactor 1110), and/or a regeneration oxidizer 1101 could be used. In some instances, the system feed 1102 could continue being fed into the reactor 1110, but the flow rate could be changed. In some instances, nothing may be fed into the reactor 1110 during a thermal cycle. In some embodiments, in addition to and/or alternative to heating or cooling the reactor 1110 by increasing or decreasing the heat supplied to the reactor 1110; modulating the flow (e.g., regeneration oxidizer 1101, system feed 1102, and/or inert gas flow 1103) being fed into the reactor 1110 can also be used to create a thermal cycle (heating or cooling depending on the particular properties of the provided gas flow). In some embodiments, the thermal cycle can be determined by a fixed period of time, a fixed target temperature, sensor readings (as discussed above), and/or any combination thereof. In some instances, mechanical removal (such as rotating element(s) and/or another mechanical removal process) can be performed during and/or after the thermal cycle. In some embodiments, some and/or all of the carbon gasified to carbon monoxide and/or carbon dioxide during the regeneration process can be captured within the system 1100 to further reduce direct carbon dioxide emissions.

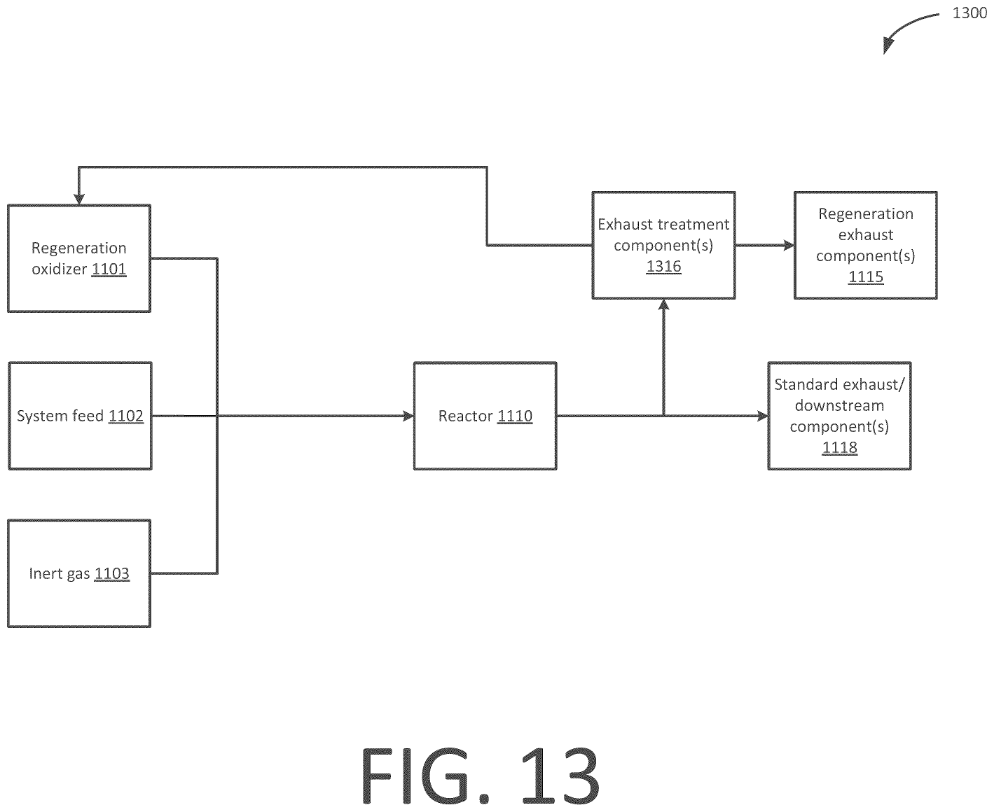

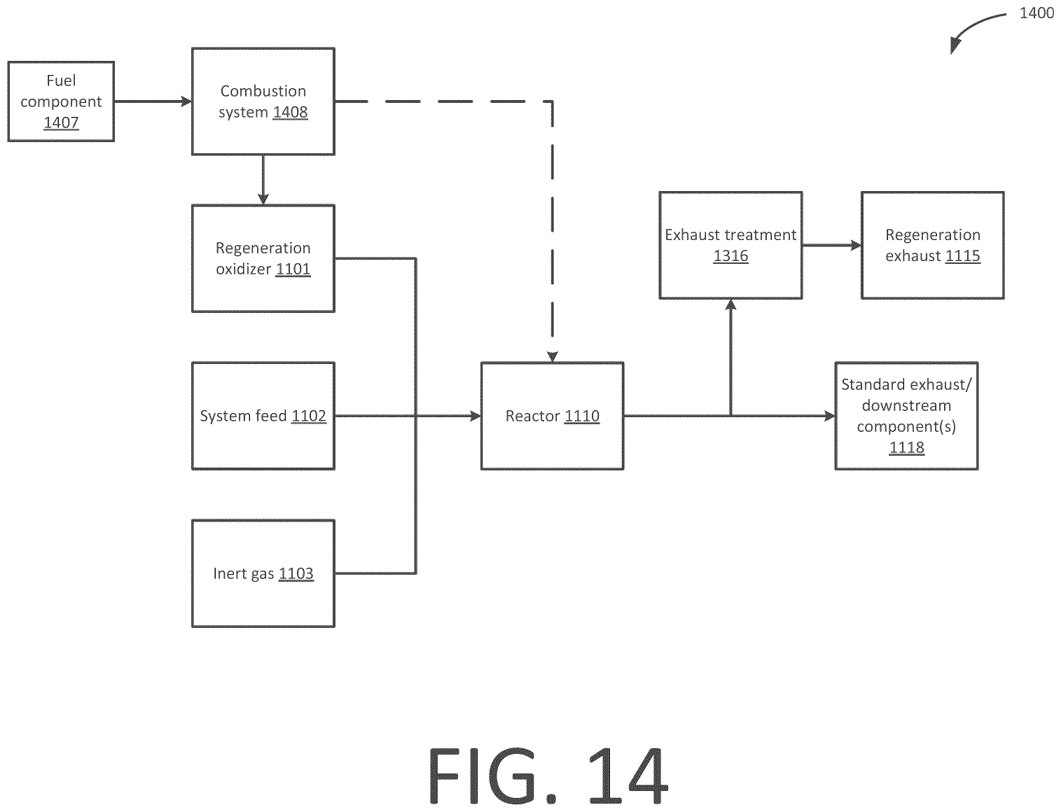

In some embodiments, the pyrolysis system (such as system 1100) can include additional and/or alternative components. FIGS. 13 and 14 illustrate some such exemplary systems. For instance, FIG. 13 is a schematic diagram of a pyrolysis system 1300 with regeneration capabilities, according to an embodiment. System 1300 can be similar to system 1100, but can further and/or alternatively include exhaust treatment component(s) 1316. In this exemplary embodiment, the exhaust treatment component(s) 1316 can use a reverse reaction to help decarbonize the regeneration product(s). As discussed herein, one example reverse reaction is the Boudouard reaction (2CO→C+CO₂). Another example reverse reaction is the Bosch reaction (CO₂+2H₂→C+2H₂O). Which reaction is utilized (e.g., the Boudouard reaction or the Bosch reaction) can depend on the concentration of carbon monoxide and/or carbon dioxide produced within the reactor 1110 during regeneration, in some instances.

The Boudouard reaction may be facilitated by flowing carbon monoxide (CO)-rich exhaust through high surface area carbon produced by the pyrolysis reactor 1110 itself. Similarly, the Bosch reaction may use hydrogen produced by the pyrolysis reactor 1110 itself to reduce any carbon dioxide (CO₂). In some instances, the exhaust treatment component(s) 1316 can utilize additional heat input or other types of catalysts to increase its efficacy, and any generated solid carbon can be routed into the typical downstream component(s) 1118 and/or carbon handling stream of the pyrolysis reactor 1110.

In some instances, the resulting effluent gas from the exhaust treatment component(s) 1316 may be recycled back into the original source of regeneration oxidizer 1101, recycled back into the reactor 1110 as the regeneration oxidizer 1101, etc. The recycling can occur, in some instances, if carbon dioxide is used as the regeneration oxidizer 1101 because the mass balance is closed and, in principle, no additional carbon dioxide emissions are created.

In some embodiments, alternatively and/or in addition to treating the regeneration product stream of the high temperature steam regeneration cycle (which can primarily consist of carbon monoxide (e.g., approximately 40%) and hydrogen gas (e.g., approximately 50%)), the resulting effluent gas can be used to heat the pyrolysis reactor 1110 (e.g., by being transmitted to a burner, combustion system, and/or another heat source), helping reduce product gas recycle, and/or can be supplied to potential syngas customers, and/or other uses.

In some embodiments, the pyrolysis system includes a heat source such as a combustion system. FIG. 14 illustrates one such pyrolysis system 1400 with regeneration capabilities, according to an embodiment. System 1400 can be similar to system 1100 and/or 1300, with the addition of a heat source (such as a combustion system 1408, in some instances). When the system 1400 includes a combustion system 1408 (or another heat source), the source of regeneration oxidizer 1101 can be sourced from within the combustion system 1408 used to heat and/or power the reactor 1110, rather than a separate source, in some instances. In the exemplary embodiment illustrated in FIG. 14, the pyrolysis system 1400 can include a fuel component 1407 that can be the source of a hydrogen/hydrocarbon mixture which is combusted with air in the combustion system 1408 to produce thermal energy provided to the reactor 1110. A flue gas product can, in some instances, be output from the combustion system 1408 and completely and/or partially directed/transmitted to the regeneration oxidizer 1101 source. The flue gas transmitted from the combustion system 1408 to the regeneration oxidizer 1101 source can be composed of a mixture of steam, oxygen, and/or carbon dioxide, depending on the properties of the fuel/fuel component 1407 and the combustion system 1408.

In exemplary embodiments, pyrolysis system 1100, 1300, and/or 1400 can run pyrolysis (e.g., run in pyrolysis mode) for a given period of time, until a given thickness of carbon has accumulated in the reactor 1110, and/or the like. In some instances, mechanical carbon removal (such as rotating element(s) and/or another mechanical removal process) can be performed during pyrolysis, and can continue throughout various other operations (including regeneration, inert gas purge, etc.). In some embodiments, as discussed herein, an inert gas 1103 can be fed into the reactor 1110 to purge the reactor 1110 and make it safe to insert oxygen-containing chemical(s) into the reactor 1110. The reactor 1110 can also start to cool due to the reactor 1110 being turned off and/or the heat input to the reactor 1110 being reduced, in some instances. Once the reactor 1110 has been appropriately purged using inert gas 1103, air and/or another regeneration oxidizer 1101 can be introduced to the reactor 1110 (for example, at a high flow rate) in the forwards direction, in an exemplary instance. This can help blow out (i.e., transmit out) soft particulates from the reactor 1110, further helping clean/clear the reactor 1110, and can be done for a defined period of time, in some instances. In some instances, the flow of air and/or regeneration oxidizer 1101 can be reversed, possibly at a lower flow rate, to help better weaken the carbon buildup in harder to reach portions of the reactor 1110 (e.g., further back areas in the reactor 1110) as the regeneration oxidizer 1101 in the forward-flowing path may be depleted (e.g., already turned into regeneration product (i.e., carbon monoxide and/or carbon dioxide) before reaching carbon in the back of the reactor). In some instances, the system can flow either a set amount of regeneration oxidizer 1101 and/or an amount based on sensor readings of carbon thickness, and then stop the flow of regeneration oxidizer 1101 and stop regeneration mode. The system can, in some instances, do another inert gas 1103 purge after regeneration mode. In some embodiments, after regeneration (and, in some instances, during the inert gas 1103 purge), the reactor 1110 can continue to cool until a target temperature has been reached, and then the reactor 1110 can be heated back up to standard operating conditions. The change from cooling to heating may happen while regeneration oxidizer 1101 is flowing, while inert gas 1103 is flowing, after regeneration is complete, and/or while system feed 1102 is flowing (i.e., after pyrolysis has restarted). The system can, in some instances, restart pyrolysis once the reactor 1110 has been purged of inert gas and oxygen, and is at a sufficiently high temperature to drive the desired reaction.

In some embodiments, thermal cycling (e.g., the cooling and heating of the reactor) can be skipped, for example if the reactor 1110 has so much thermal mass that little change in temperature can be achieved. In some embodiments, limits on carbon dioxide and/or carbon monoxide emissions can be used to determine when to stop regeneration, even if carbon thickness and/or other sensor readings are not yet satisfactory. In these instances, the reactor 1110 may eventually have to shut down for a maintenance cycle and/or a more traditional regeneration cycle where carbon can be more completely oxidized to reset the reactor 1110. The regeneration duty cycle can also be varied. As a non-limiting example, the system can have a plurality of short pyrolysis/regeneration cycles, followed by a longer and more thorough regeneration cycle. In some embodiments, additional and/or alternative methods of weakening carbon buildup within the reactor 1110 can be used. Some example methods include applying vibration and/or mechanical stress to the carbon, finding liquids that react with the carbon buildup, using steam as the regeneration oxidizer 1101, etc.

As discussed herein, the various embodiments discussed above can be a part of a system that includes a reactor, such as a pyrolysis reactor. For example, rotating element(s) (e.g., 105, 205, 305, 405, 505, 605, 805, and/or 905) can be used within a reactor to remove carbon buildup from the reactor and the reaction chamber (e.g., pyrolysis chamber) of the reactor. Alternatively or additionally, the reactor can include regeneration capabilities such that a regeneration oxidizer can be fed into the reactor to react with the carbon buildup in order to help remove the carbon and/or make it easier to remove through other means (such as the rotating element(s) and/or alternative carbon removal methods).

In some embodiments, a reactor, as referred to herein, is an arrangement of elements that constitute a device which can support the steady state conversion of an input flow of hydrocarbons (such as methane, propane, biogas, natural gas, etc.) into output flow(s) (e.g., product stream(s)) of hydrogen gas, solid carbon, and a combination of unreacted hydrocarbons and other intermediates (such as intermediate polyaromatic hydrocarbons (PAHs)). In some embodiments, the hydrogen gas, solid carbon, and a combination of unreacted hydrocarbons and other intermediate PAHs can exit the reactor in a single product stream. In some embodiments, one or more of hydrogen gas, solid carbon, and/or a combination of unreacted hydrocarbons and other intermediate PAHs can exit the reactor in different product streams. In target applications for the reactor and/or corresponding system, the hydrogen gas and solid carbon are saleable product streams once separated from the unreacted hydrocarbons and PAHs. In some embodiments, the conversion can be accomplished through high temperature pyrolysis, therefore, in some instances, the reactor can be a pyrolysis reactor. The reactor (e.g., pyrolysis reactor) and/or corresponding system (e.g., pyrolysis system), as discussed herein, can be an efficient, modular, self-contained, and scalable system suitable for long duration operation in a wide range of industrial and process applications.

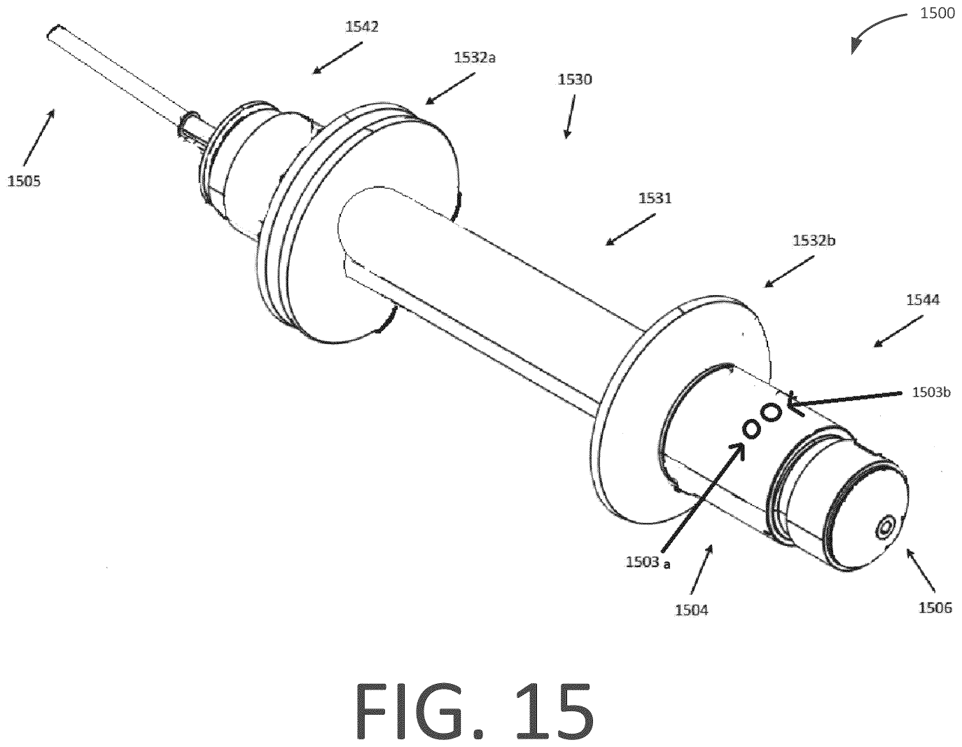

FIG. 15 illustrates an external view of one such example pyrolysis reactor 1500, according to an embodiment. In some embodiments, as discussed further herein, the reactor 1500 can include a pair of coaxially arranged but non-concentric tubes capable of sustained operation at high temperatures (for example, between 600° C. and 2000° C.). The pyrolysis reaction can occur in the space between the two tubes, in some instances. In order to generate suitable temperatures for a pyrolysis reaction to occur, reactor 1500 can include a heat source 1505. In some embodiments, discussed further herein, the heat source 1505 can be within an inner tube (of the two tubes). In an example embodiment, depicted in FIG. 15, the heat source 1505 can be a burner 1505 that extends beyond the pair of tubes but also extends (within the reactor) to an area within the inner tube (of the pair of tubes). In some embodiments, although FIG. 15 depicts a burner as the heat source 1505, the heat source 1505 could be a different heat source such as a resistive electric heater, combustion component, and/or a device producing an electromagnetic field to deliver energy to the reactants (e.g., an induction or microwave source), and/or another type of heat source.

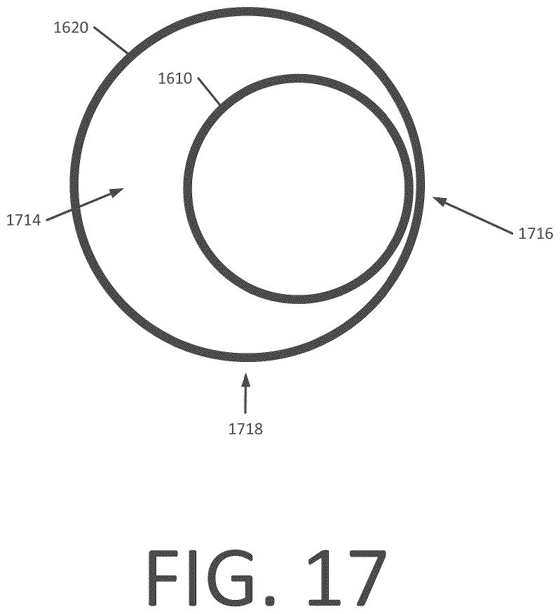

In some embodiments, the reactor 1500 can include a supply manifold 1544 to admit the source hydrocarbons (e.g., system feed 1102 and/or the like), regeneration oxidizer (e.g., regeneration oxidizer 1101 and/or the like), and/or inert gas (e.g., inert gas 1103 and/or the like) to an inflow end 1544 of the crescent shaped volume formed between the two coaxial but non-concentric tubes (for example, volume 1714 (FIG. 17), discussed further herein). In some embodiments, the supply manifold 1544 can include a first inlet 1503a and a second inlet 1503b, one or both of which can be used to admit hydrocarbons, regeneration oxidizer 1101, or other fluids for the purposes of cooling, heating, dilution, enrichment, or catalysis. Other inlets may also be provided.

In some embodiments, as illustrated in FIG. 15, the reactor 1500 can include a collector plenum 1532a (also referred to as a collector manifold 1532a) at the discharge end 1542 (also referred to as an outflow end 1542) of the multi-tube reactor 1500 system arranged to receive the product stream (i.e., the outflow hydrogen gas, solid carbon, and PAHs) from the pyrolysis process (occurring in the crescent-shaped volume formed between two coaxial, non-concentric tubes, such as crescent-shaped volume 1714). In some embodiments, the collector plenum can include a discharge port where at least hydrogen gas (and/or other components of the product stream) can be removed from the reactor 1500. In some embodiments, a manifold 1506 can be used to collect flue gas from the heat source 1505, if present, and/or the regeneration product from any regeneration cycles.

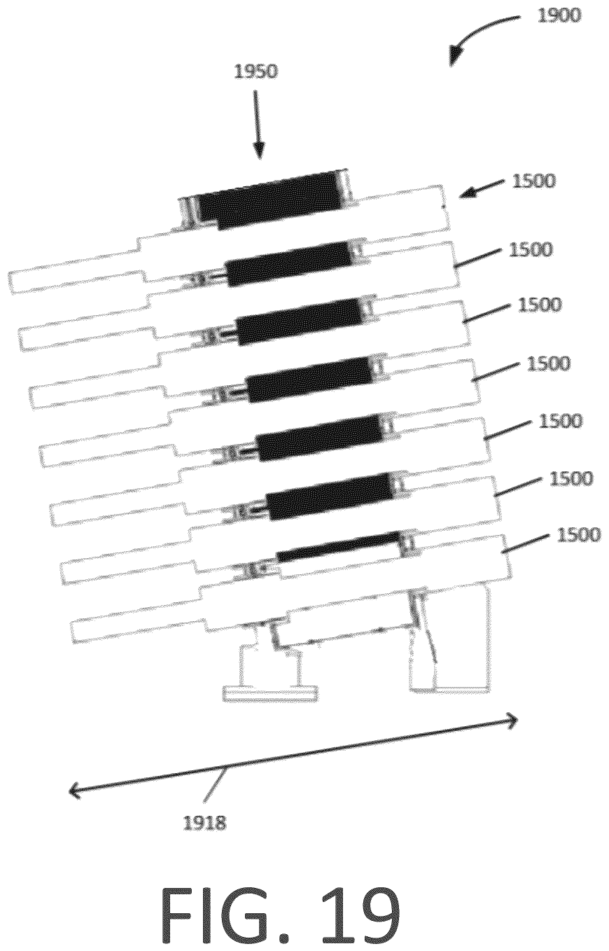

Referring to FIG. 19A, in some embodiments, an array of reactors 1900 can include a containment apparatus 1950 to contain the reactors 1500 and other components. In some instances, containment apparatus 1950 can include a pair of support elements and/or plates 1532a, b at each end of a central housing 1531. For example, a first end of the central housing 1531 (for example, near the inflow end 1542 of the reactor 1500) can include a first support element 1532a (also referred to as a support plate 1532a); and a second end of the central housing 1531 (for example, near the inflow end 1544 of the reactor 1500) can include a second support element 1532b (also referred to as a support plate 1532b). In some embodiments, one or more of the support elements 1532 can include a plurality of support elements/plates 1532. For example, FIG. 15 illustrates support element 1532a having a plurality of support plates 1532a. As another example, not depicted, support element 1532b could include a plurality of support plates 1532b and/or support element 1532a could have a singular support plate 1532a. In some embodiments, the combination of the support elements 1532 and the central housing 1950 form an enclosed volume which can be filled with appropriate thermal insulation to mitigate heat loss from the pyrolysis reactor module(s) which are mounted between the two end support elements 1532.

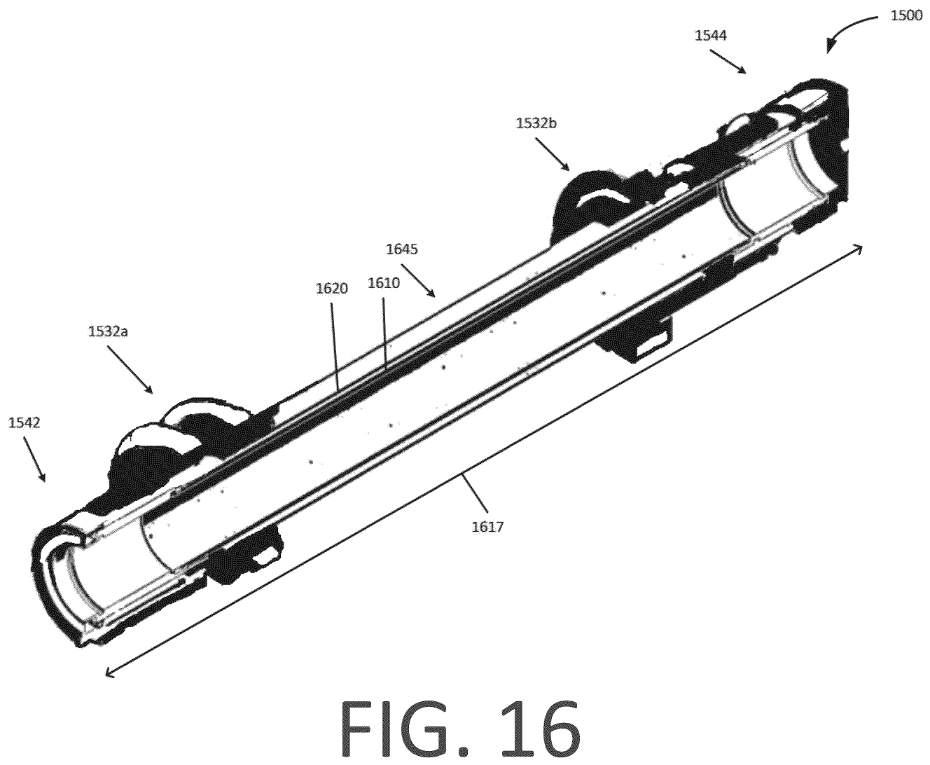

FIG. 16 illustrates a simplified cross-section (e.g., an X-Y plane cross-section) of the reactor 1500 with a two-tube arrangement, as discussed herein and FIG. 17 illustrates a simplified schematic diagram of another cross-section (e.g., a Y-Z plane cross-section) of the two-tube arrangement. For example, as illustrated in FIG. 16, the reactor 1500 can include at least two tubes-tube 1610 and tube 1620. Tube 1610 can be referred to herein as an inner tube and tube 1620 can be referred to herein as an outer tube, in some instances. As discussed herein, tubes 1610 and 1620 can be a pair of coaxially arranged, non-concentric tubes 1610, 1620. As a result of the coaxial, non-concentric arrangement of the tubes 1610, 1620, a crescent-shaped passage 1714 can be formed between the tubes 1610, 1620. This passage can also be referred to as a crescent-shaped volume 1714, as passage 1714 can constitute a volume where the pyrolysis process is stabilized. In some embodiments, tube 1610 and/or tube 1620 can be rotating element(s) (such as rotating element(s) 105, 205, 305, 405, 505, 605, 805, and/or 905). For instance, tube 1610 and tube 1620 can be supported (e.g., within the reactor 1500) such that they can be rotated about their longitudinal axis. In some instances, the rotation(s) of the tubes 1610, 1620 can be in opposing and/or counter-rotating directions. The purpose of this rotation can be to create opposing relative motion of the tubes 1610, 1620, particularly at the location where the tubes 1610, 1620 are closest to each other (shown at location 1716 in FIG. 17). In some embodiments, tubes 1610 and 1620 can be the same as and/or similar to tubes 905 and 910 (FIGS. 9A and 9B).

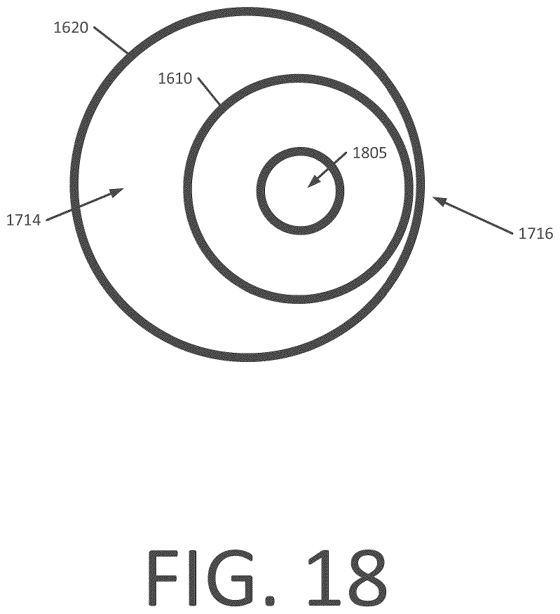

In some embodiments, as discussed herein, a heat source 1805 can be located in the center of the inner tube 1610. This is illustrated in FIG. 18. In some embodiments, the heat source 1805 can be a resistive electric heater, combustion component, a device producing an electromagnetic field to deliver energy to the reactants (e.g., an induction or microwave source), a burner, and/or another heat source 1805. In some embodiments, at least a portion of the heat source 1805 can extend beyond the inner tube 1610, as shown in FIG. 15 (1505).

Referring to FIGS. 16 and 17, during a pyrolysis operation (also referred to herein as pyrolysis mode), the tubes 1610, 1620 can be heated from the inside and/or outside while both tubes 1610, 1620 are driven to counter-rotate. In some instances, only one of the tubes 1610, 1620 may rotate. The heat source (that heats the tubes 1610, 1620) can drive the temperature of the volume 1714 to as high as 2000° C., in some instances. In some instances, the heat source can be a resistive electric heater, combustion component, a device producing an electromagnetic field to deliver energy to the reactants (e.g., an induction or microwave source), a burner, and/or another heat source. While the volume 1714 is being heated, a system feed (such as hydrocarbon(s)) can be introduced at an inflow end 1504 of the reactor 1500 and can flow along the length (such as length 1617) of the crescent-shaped cross-sectional passage (e.g., volume 1714) formed between the two tubes 1610, 1620. As the system feed flows along this passage, the system feed can pick up heat from the tube 1610. As discussed herein, a heat source can be in a center of the inner tube 1610, in some instances. As the system feed approaches a half way point (e.g., half way point 1645) along the axial length of the space between the two tubes 1610, 1620 (e.g., volume 1714), the system feed can achieve its maximum temperature and the pyrolysis process (e.g., pyrolysis reaction) can proceed at its maximum rate, and almost all of the system feed (e.g., hydrocarbon(s)) can be converted to hydrogen gas, solid carbon, and/or PAHs.

In some embodiments, a fraction of the carbon that forms can flow as part of the product stream (e.g., along with the hydrogen gas) and/or can settle onto the surfaces of the tubes 1610, 1620 as a soft powder. The remainder of the carbon, in some instances, can build up on the hot walls of the rotating inner tube 1610 and outer tube 1620 (also referred to herein as rotating elements) via chemical vapor deposition (CVD). The high surface temperature of the walls of the tubes 1610, 1620 can cause a very hard, dense layer of carbon to develop on these surfaces. This hard, dense layer of carbon is referred to herein as carbon buildup. If the carbon buildup were not removed from the surface(s) of the tubes 1610, 1620, it could progressively accumulate and eventually fill and block the entire space between the tubes (in some instances, including the crescent-shaped space 1714 and/or the smaller space at location 1716).

However, in the two tube coaxial, non-concentric arrangement of tubes 1610, 1620, the combination of the counter-rotation of the tubes 1610, 1620 and the narrow gap 1716 formed at the minimum spacing of the crescent-shaped cross-section 1714 between the tubes 1610, 1620 creates a zone (can be referred to herein as zone 1716) where the hard carbon (i.e., the carbon buildup) on the surface of the outer tube 1620 is scraped and/or ground against the hard carbon on the surface of the inner tube 1610. In some instances, with an appropriate choice of tube 1610, 1620 diameters, speeds, and carbon deposition rates, an equilibrium condition can be established where the carbon buildup on the surfaces of the tubes 1610, 1620 is ground off and removed (for example due to the rotating tubes 1610, 1620 (also referred to herein as rotating elements)) at a rate equal to the rate at which it is forming. This condition is represented schematically in FIG. 2. As the carbon buildup is removed via this grinding process, it is reduced to a powder like form which falls to the lowest point 1718 on the crescent-shaped cross-sectional area 1714 between the tubes 1610, 1620. The carbon powder that has fallen to the lowest point 1718 can then roll along this zone/area, driven by the rotation of the tubes 1610, 1620, fluidization by gas flow, or both, and can be conducted axially along the length (e.g., length 1617) of the gap/opening between the tubes 1610, 1620 along with the hydrogen gas and PAHs. Put differently, after being ground and reduced to a powder, the carbon buildup powder and can fall to the lowest point 1718 and then be carried out of the reactor 1500 along with the product stream (including hydrogen gas and PAHs) flowing through and then out of the reactor 1500. Ultimately, the flow of the product stream (including hydrogen gas, PAHs, and any unreacted hydrocarbons) along with the carbon buildup powder (also referred to herein as solid carbon powder) flows out the space between the tubes 1610, 1620 at the outflow end 1544 and flows into the collector plenum 1532a. Once in the collector plenum 1532a, the carbon powder can fall to the bottom of the collector 1504 where it can be removed from the reactor 1500, and the hydrogen gas can be removed from the reactor 1500 through the carbon collector plenum 1532a.

In some embodiments, the scraping and/or grinding (of the rotating tubes 1610, 1620 and/or other rotating element(s) discussed herein) can be done for an extended period in an inert environment (i.e., the rotating tubes 1610, 1620 and/or other rotating element(s) discussed herein can have an extended period of grinding/scraping in an inert environment). This increases the coefficient of friction and/or carbon removal. Scraping and/or griding can refer to the carbon scraping due to the rotating of one or more tubes and/or rotating elements. In some embodiments, an inert environment is a non-reactive environment within the reactor 1500 and/or passage 1714. As an exemplary embodiment, the inert environment can be established by an inert gas feed/flow (such as inert gas flow 1103, for example).

As discussed herein, the wall temperatures (for example, of at least the walls of the tubes 1610 and 1620) required to heat the system feed (e.g., hydrocarbon(s)) adequately to drive rapid pyrolysis (for example, temperatures of between 600° C.-2000° C.) result in the accumulation of a dense hard carbon coating or layer (referred to herein as carbon buildup) on the walls that define the pyrolysis zone (i.e., the outer wall(s) of tube 1610 and the inner wall(s) of tube 1620). The outer wall(s) of tube 1610 and the inner wall(s) of tube 1620 can be the same as and/or similar to outer surface 107 and second surface 110 (FIG. 1), respectively; outer surface 507 and inner surface 510 (FIG. 5A), respectively; outer surface 907 and inner surface 908 (FIGS. 9A and 9B), respectively; etc., in some instances. The hard carbon buildup together with the powder-like gas-borne carbon, which flows along with the product stream and/or the hydrogen gas product, constitute the total carbon production of the reactor 1500 and/or the system. While the gas borne carbon powder can flow readily out of the reactor, an additional mechanism is required to continuously remove the hard carbon buildup from the walls of the reaction tubes 1610, 1620 and convert it into a form that can be readily and continuously discharged from the reactor 1500.

In some embodiments, the additional mechanism can be the rotating elements/tubes discussed herein (such as rotating elements 105, 205, 305, 405, 505, 605, 805, and/or 905; and/or rotating tubes 1610, 1620). Given the density and hardness of the hard carbon (i.e., carbon buildup) layer on the walls of the reaction tubes 1610, 1620, the reactor 1500 can remove the carbon buildup by scraping one hard carbon coated surface against another (i.e., scraping hard carbon (i.e., carbon buildup) against hard carbon (i.e., carbon buildup). In instances where the rates of accumulation and removal of the carbon buildup layer on the respective surfaces/walls of the tubes 1610, 1620 can be nearly balanced, the reactor 1500 system and the rotating element/tube configuration can result in an equilibrium and/or near equilibrium condition (for instance, a condition of continuously reducing the carbon buildup coating on both surfaces (i.e., an inner wall of tube 1620 and an outer wall of tube 1610) to a powder-like form that can be readily conducted out of the reactor 1500 and supporting continuous and/or nearly continuous operation).

In an equilibrium condition where the removal and deposition rates of carbon buildup are balanced, the scraping and/or grinding process (of the rotating tubes 1610, 1620) can require a normal or contact force between the two surfaces (i.e., an inner wall of tube 1620 and an outer wall of tube 1610). This force can be generated by the bending deflection of the inner tube 1610 relative to the outer tube 1620. The bending load can be reacted by the bearing system, which is discussed further herein.

In some embodiments, the support structure for the bearings/bearing system can be equipped with strain gages or other appropriate deflectometer that provide real time feedback as to the normal force created by the accumulation of hard carbon (i.e., carbon buildup) on the tube walls and grinding of the two hard carbon coated surfaces (i.e., an inner wall of tube 1620 and an outer wall of tube 1610). If the carbon buildup is accumulated at a rate greater than it is being removed, after time the bending deflection of the tubes 1610, 1620 could exceed the strength of the tubes 1610, 1620 and one or both of the tubes 1610, 1620 could fail.

To help avoid excessive hard carbon accumulation (i.e., excessive carbon buildup), regeneration can be used, in some instances. As discussed herein, regeneration can include flowing a regeneration oxidizer through the passage 1714 (which can also be referred to herein as the reaction chamber 1714 and/or pyrolysis chamber) to react with the carbon buildup and change the structural properties of the carbon buildup. This can help remove the carbon buildup and/or make the carbon easier to remove using the rotating tubes 1610, 1620. In some embodiments, to avoid excessive hard carbon accumulation, when the normal force acting between the two counter-rotating tubes 1610, 1620 reaches a threshold level, the reactor 1500 can switch from a pyrolysis mode to a regeneration mode. Put differently, when the normal force acting between the two counter-rotating tubes 1610, 1620 reaches a threshold level, the system feed supply can be terminated and a controlled supply of a regeneration oxidizer can be supplied to the reactor 1500 instead. As the regeneration oxidizer flows through the passage 1714 between the tubes 1610, 1620, the presence of oxygen can cause oxidation of the hard carbon buildup. This can result in at least a portion of the carbon buildup being consumed and removed via oxidation and/or the carbon structural properties being changed to make the carbon buildup easier to remove by the rotating tubes 1610, 1620. In some embodiments, a real time tube bending load measurement (for tubes 1610 and/or 1620) can be provided by the strain gages or deflectometer and can provide a control variable to limit the use of the regeneration process (also referred to herein as a regeneration mode) to an as needed basis).

As discussed herein, regeneration can result in a decreased system efficiency and an increase in carbon dioxide emissions due to the stopping of pyrolysis (to avoid explosive mixtures) and output of regeneration products (which, as discussed herein, can include carbon dioxide). Nonetheless, periodic intermittent regeneration is an effective option to enable long term and reliable system and reactor (e.g., reactor 1500) operation. Further, as discussed herein, regeneration can be run for a relatively short period of time such that the carbon buildup is not fully consumed/removed from oxidation, and instead the structural properties of the carbon buildup have been changed to make the carbon easier to remove. This can reduce the amount of decreased system efficiency and reduce the increase in carbon dioxide emissions due to regeneration, as the regeneration is run for a shorter period.

Referring now to FIG. 19, an array of reactors 1900 are depicted, according to an embodiment. In some embodiments, as discussed herein, the gas borne carbon powder, and even the carbon powder created by the carbon-on-carbon grinding process (from the rotating tubes 1610, 1620 within each reactor 1500), can be convected along a length (such as length 1617 in FIG. 16) of the crescent-shaped annulus/passage 1714 between the tubes 1610, 1620 by the inflowing system feed (e.g., hydrocarbon(s)) and outflowing hydrogen gas. Larger pieces of carbon that may be formed in the carbon-on-carbon griding process, however, may be large enough such that they cannot be convected (or it is much more difficult to convect) out of the reactor 1500 by momentum exchange with gas flow alone. Therefore, in some instances, in order to provide an additional driving force to carry the larger fragments of carbon buildup out of the reactor 1500, the arrangement of coaxial, non-concentric rotating tubes 1610, 1620 (and/or the entire reactor 1500 arrangement) can be inclined 1918 at an appropriate angle relative to horizontal. This creates a component of gravity acting in the axial direction, which provides an additional force to drive any larger pieces of carbon buildup out of the reactor tube/chamber and into the collector plenum 1504.

In some embodiments, as illustrated in FIG. 19, a system can include an array 1900 of reactors 1500 (also referred to herein as reactor modules 1500 and/or reactor assemblies 1500) mounted in a containment vessel 1950. This can increase hydrogen production and can, in some instances, reduce system inefficiencies due to regeneration. For instance, one or more reactors 1500 can be in a pyrolysis mode (i.e., undergoing pyrolysis and producing a product stream including hydrogen gas) while another one or more reactors 1500 are in a regeneration mode (i.e., undergoing regeneration). This can help prevent excess carbon buildup while ensuring that at least one reactor 1500 is producing hydrogen gas at all times. In some embodiments, as illustrated in FIG. 19, the array 1900 of reactors 1500, as well as the containment vessel 1950, can be inclined 1918 relative to the horizontal.

As discussed herein, high temperature pyrolysis can reach very high temperatures (for example, up to 2000° C.). These high pyrolysis temperatures necessitate the use of materials capable of operation at very high temperatures. Therefore, in some embodiments, the inner and outer reactor module tubes (tubes 1610 and 1620, respectively) can be workable with materials such as engineered toughened ceramics. Examples of engineered toughened ceramics include alumina (Al₂O₃), mullite (Al₂O₃+SiO₂), silicon carbide (SiC), silicon nitride (Si₃N₄), ceramic matrix composites (CMCs), and/or other engineered toughened ceramics. While these example materials have the thermal capability required to support the pyrolysis process, the need to mount bearings, drive gears, and/or other mechanical features to the tubes 1610, 1620 necessitates a transition from the ceramic tube(s) 1610, 1620 to a more conventional high temperature metal alloy on each end of both the inner tube 1610 and the outer tube 1620. The attachment of these metal ends and/or adapters to each end of the ceramic tubes 1610, 1620 is made challenging by the difference in coefficient of thermal expansion (CTE) between the ceramic material(s) of the tubes 1610, 1620 and the appropriate high temperature alloy material(s) of the metal ends/adapters.

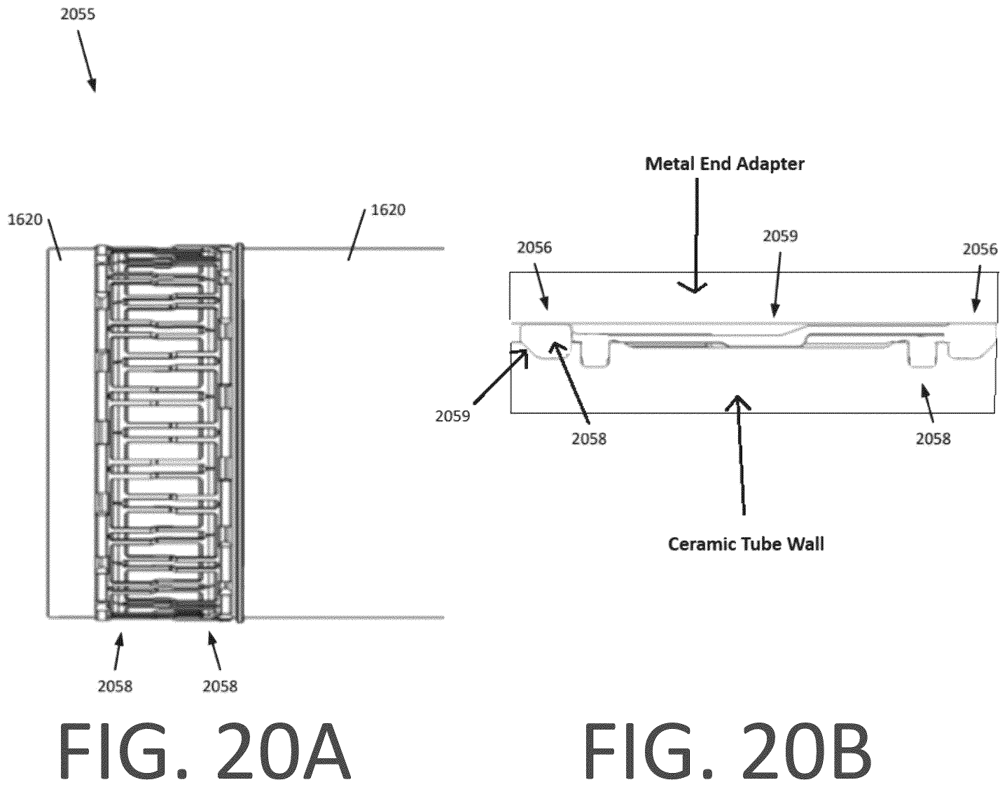

FIGS. 20A and 20B illustrate a metal end adapter assembly 2055 that can attach to both ends of each tube 1610, 1620. FIG. 20B illustrates a cross section through the metal end adapter assembly 2055 on one end of tube 1620 highlighting the wall of the ceramic tube, metal adapter and an intermediate element between the adapter 2055 and the ceramic tube 1620. However, as discussed herein, metal end adapter assembly 2055 can also be on the second end of tube 1620 as well as both ends of tube 1610. FIG. 20A shows the intermediate metal element 2058 on the end of the ceramic tube with the metal adapter not shown for clarity.

In some embodiments, metal end adapter assembly 2055 can be a two-element system of metal alloy parts that operate together to accommodate the CTE mismatch between the ceramic reactor tube (1610 and/or 1620) and a metal end adapter (e.g., metal end adapter assembly 2055) which can accommodate the attachment and integration of machine elements required to support and drive the reactor tubes 1610, 1620. The metal end adapter assembly 2055 can include an outer metal adapter sleeve 2056 that, in some instances, is made of an appropriate alloy capable of operating and retaining adequate strength at elevated temperatures up to 300° C.-800° C. (as the temperature in this area of the reactor 1500 may be high, but not as high as the pyrolysis region and the pyrolysis operating temperature(s)). The sleeve 2056 can be positioned concentrically around the tube (in this exemplary instance, tube 1620) with an annular gap between the outer wall of the tube 1620 and the inner wall of the metal adapter sleeve 2056.

The second metal alloy element 2058 (also referred to herein as an intermediate annular element 2058) can be positioned in the annular gap between the tube 1620 and the outer metal adapter sleeve 2056. The intermediate annular element 2058 can be designed to exploit its own thermal growth along the longitudinal axis of the tube. For instance, as the intermediate annular element 2058 grows in the axial direction, due to high temperature operation, ramp shaped features 2059 on each of the axial ends of the metal end adapter assembly 2055 can engage with corresponding ramp shaped features that are formed into the outer wall of the tube(s) 1610, 1620. As the axial thermal expansion of the intermediate annular element 2058 drives it increasingly into contact with the corresponding feature on the tube (e.g., 1610 and/or 1620), the two ramped shaped features (including 2059) work together to drive the intermediate annular element 2058 radially outward so as to continuously fill the growing gap between the tube (e.g., 1610 and/or 1620) and the outer metal adapter sleeve 2056. This can maintain a tight fit capable of transmitting the required loads from the tube (e.g., 1610 and/or 1620) into the metal end adapter assembly 2055.

In some embodiments, the intermediate annular element 2058 is formed with an interrupted structure in the circumferential direction. This can allow the intermediate annular element 2058 to grow in the longitudinal and/or axial direction in response to increasing operating temperatures as described herein (for example, driving the desired interaction of the ramp shaped features 2059 on the metal end adapter assembly 2055 with the corresponding ramp shaped features on the wall of the tube (1610 and/or 1620)). The interrupted shape allows the intermediate annular element 2058 to avoid the circumferential growth that would otherwise occur if the element 2058 were continuous in the circumferential dimension. In some embodiments, the metal end adapter assembly 2055 can be removed from one tube and installed on another tube interchangeably in the event of failure of a tube.

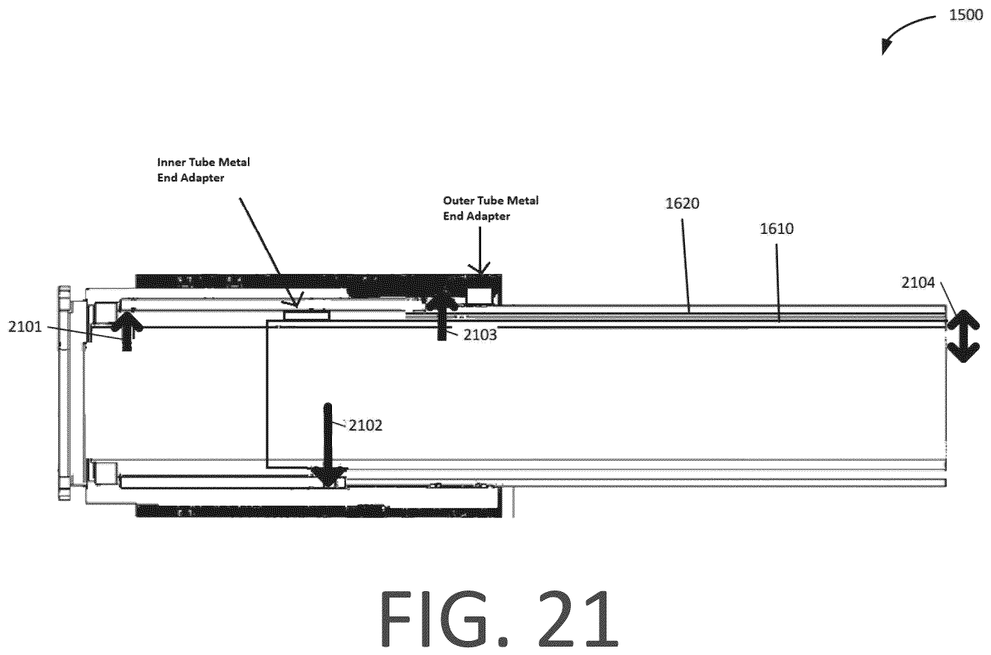

FIG. 21 illustrates location of reaction loads and associated bearing structures in the reactor 1500, according to an embodiment. As discussed herein, the reactor 1500 can include one or more rotating elements (for example, rotating tubes 1610 and 1620). The internal load carrying features of the reactor 1500 may have an arrangement that supports the counter-rotating reactor tubes 1610 and 1620. For instance, in order to avoid challenging end to end alignment requirements for the reactor 1500, the reactor assembly may be completely modular and structurally self-supporting. FIG. 21 depicts a carbon outlet end of the reactor 1500 with reaction loads F₁ (2101), F₂ (2102), and F₃ (2103) acting at the three radial bearing locations. In some embodiments, the opposite end to the reactor 1500 can be the mirror image of this bearing arrangement. During operation, the carbon buildup between the reactor tubes 1610, 1620 and the associated self-scraping action (i.e., the rotating/moving of the tube(s) 1610, 1620) can create a normal force (F_{c}) 2104 at an interface between the carbon buildup (i.e., hard carbon) on the outer wall of the inner tube 1610 and the inner wall of the outer tube 1620. This normal force 2104 can create an internal spreading action which can load the two reactor tubes 1610, 1620 in bending.

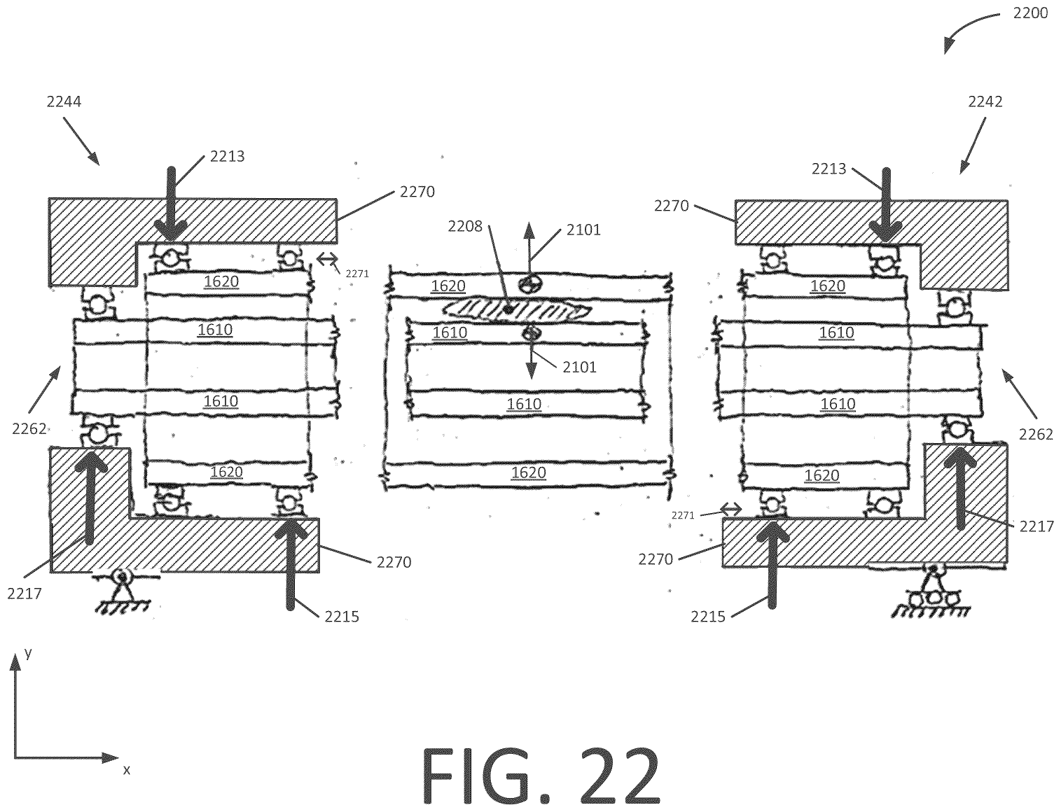

FIG. 22 illustrates a free body diagram of a counter-rotating two tube reactor 2200, according to an embodiment. In some embodiments, reactor 2200 can be the same as and/or similar to reactor 1500. As depicted in FIG. 22, reactor 2200 can include an inner tube 1610 and an outer tube 1620. Further, as discussed herein and depicted in FIG. 22, hard carbon 2208 can buildup (i.e., carbon buildup 2208) between the outer tube 1620 and the inner tube 1610. In some embodiments, the inner tube 1610 assembly can extend beyond the end of the outer tube 1620 (shown by arrows 2262). This can be necessitated, in some instances, by the high temperatures being concentrated toward a center span of the reactor tubes 1610, 1620 and physical space requirements to accommodate both an inflow of a system feed (e.g., hydrocarbon(s)) (at inflow end 2242) and an outflow of carbon and hydrogen (at outflow end 2244). This arrangement can result in the bearings (e.g., bearings support structures 2270) required to support the two counter-rotating reactor tubes 1610, 1620 being offset (e.g., 2271) from each other in the longitudinal or axial direction. This offset (2271) between the bearings 2270 can result in a moment applied to the bearing support structure 2270 that would typically require some form of external and rigid support for the bearing support structure(s) 2270. For instance, either anchoring both bearings cartridges rigidly to a foundation element or, alternatively, to each other. This independent load path is a complicating requirement for the design of the integrated system and would couple the reactor 1500 to some additional element and/or assembly.

In some embodiments, an alternate approach can be employed that depends on a statically indeterminate bearing arrangement which complicates the analysis of the loads but eliminates the need of any external load path between the bearing support structures 2270 on each end of the reactor 2200 (also referred to as a reactor module 2200). The elimination of the need for an external load path or connection of the baring support structures 2270 may be a significant simplification of the design. Eliminating the need for the external load path/connection can mean that the bearing support structure 2270 on each end of the reactor 2200 requires only a simple and non-rigid support which can simply support the reactor 2200 against gravity loads. In the case of a system with an array of reactors/reactor modules 2200 mounted in a housing (the same as and/or similar to array 1900, in some instances), this alternate approach can eliminate the need to maintain any careful alignment of the support features at one end of the housing to the features on the other end of the containment housing.

In some embodiments, as illustrated in FIG. 22, the reactor 2200 can include at least reaction force (R₁) 2213, reaction load (F₁) 2101, reaction force (R₂) 2215, and reaction force 2217. In some embodiments, as an example, reaction force 2217 can be approximately between 1,000 and 10,000 pounds.

In some reactor systems, the support of the inner and outer tubes 1610 and 1620, respectively, could be accomplished by rolling element bearings (including, but not limited to, some form of ball, needle, and/or cylindrical element bearings). However, these types of bearings may require lubrication, which have operating temperature limitations and physical form factors that would make their integration into a pyrolysis reactor (such as reactor 1500, reactor 2200, etc.) difficult. Additionally, use of any sort of conventional rolling element bearing would require some form of cooling. This cooling could be accomplished by active recirculation and cooling of the lubricant, however the seals, lines, external cooler, and/or other ancillary systems required to execute this functionality would have an undesirable impact on the size and cost of the modular reactor assembly.

Therefore, in order to avoid these negative impacts on system cost and size, reactor 2200 (and reactor 1500, in some instances) can include custom low profile hybrid bearings 2270 (for example, ceramic rolling elements and high temperature metal races) to support both the inner and outer reactor tubes (tubes 1610 and 1620, respectively). Both hybrid bearings and all ceramic bearings are recognized as being able to operate without conventional hydrodynamic lubrication either completely unlubricated or with only dry film lubricant. In addition, the hybrid bearings and all ceramic bearings are well proven in high temperature applications (which is desirable for high temperature pyrolysis). In some embodiments, clean cool buffer inert gas can be circulated through the bearings 2270 to maintain them at desired operating temperatures and simultaneously create a positive pressure in the bearing galleries to prevent the ingress of any product carbon powder, gas, and/or other contaminates.

In some embodiments, the various components discussed herein can operate at a higher process pressure (for example, up to 100 bar), operate with different cooling media (for example, oils, using process flows as coolant, and/or other cooling media), operate at lower temperatures with superalloys in lieu of ceramic heat exchange tubes, operate with reciprocation and/or helical movement of the tubes, and/or other additional or alternative operation variants.

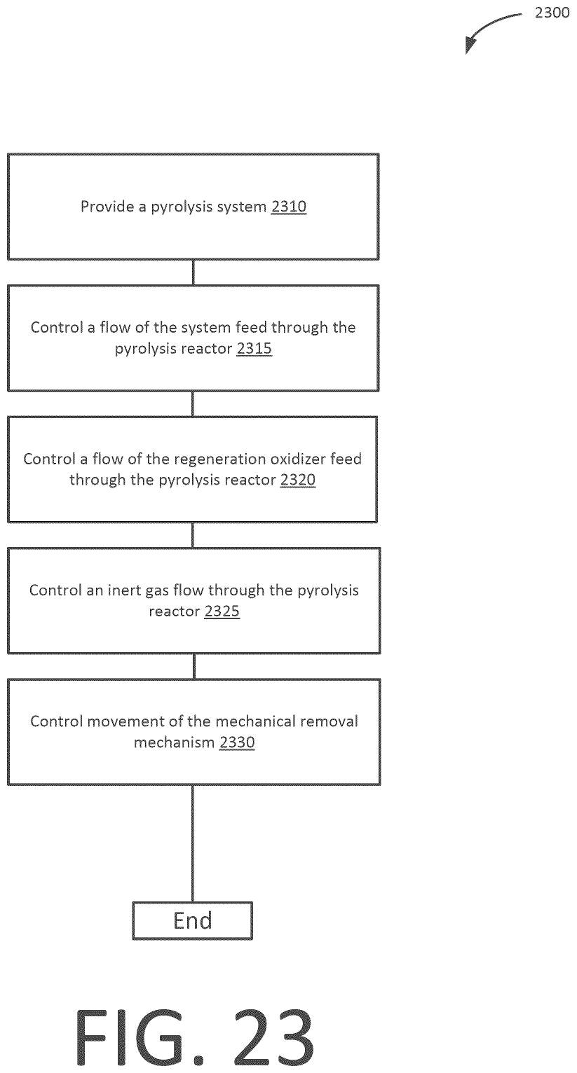

FIG. 23 illustrates an example method of removing carbon buildup from a reactor, according to an embodiment. In some embodiments, method 2300 can be executed by systems and/or components such as those discussed herein in relation to FIGS. 1-22. In some embodiments, the various system(s) discussed herein can include one or more controllers, and the method 2300 can be executed by the controller(s) of the system. While example operations for method 2300 are discussed below, method 2300 can include any removal methods and/or techniques discussed herein.

Method 2300 can include operation 2310 to provide a pyrolysis system. In some embodiments, the pyrolysis system can include a pyrolysis reactor, a regeneration oxidizer feed, and a mechanical removal mechanism. As discussed herein, the pyrolysis reactor can include a pyrolysis chamber configured to generate a product stream from a system feed, where the system feed comprises a hydrocarbon reactant, and where the product stream comprises hydrogen gas and solid carbon. In some embodiments, as discussed herein, a regeneration oxidizer feed can be fed into the reactor with the intention of altering the structural properties of the carbon buildup without fully removing the carbon buildup. This can help make carbon removal easier through mechanical means (i.e., a mechanical removal mechanism) while also preventing excess carbon dioxide emissions due to a full regeneration reaction and duration (as the regeneration mode may not be executed for a full duration). In some embodiments, the pyrolysis reactor can be a reactor such as reactor 1500 and/or 2200 and can include a pair of coaxially arranged but non-concentric tubes (such as tubes 1610 and 1620). These tubes can be counter-rotating tubes, in some instances. In some embodiments, the rotating tubes (e.g., 1610 and 1620) are the mechanical removal mechanism. In some embodiments, the pyrolysis system can include additional and/or alternative components such as those discussed herein.

Method 2300 can include operation 2315 to control a flow of the system feed through the pyrolysis reactor. As discussed herein, the system feed and the regeneration oxidizer should avoid being fed into the reactor at the same time, in most instances. Therefore, in some instances, controlling the flow of the system feed can include, when the pyrolysis system is in a pyrolysis mode, feeding the system feed through the pyrolysis reactor, and, when the pyrolysis system is in a regeneration mode, stopping flow of the system feed through the pyrolysis reactor. In some instances, operation 2315 can include additional and/or alternative steps of controlling flow of the system feed.

Method 2300 can include operation 2320 to control a flow of the regeneration oxidizer feed through the pyrolysis reactor. In some embodiments, controlling flow of the regeneration oxidizer feed can include, when the pyrolysis system is in the pyrolysis mode, stopping flow of the regeneration oxidizer feed through the pyrolysis reactor, and, when the pyrolysis system is in the regeneration mode, feeding the regeneration oxidizer feed through the pyrolysis reactor. This can help prevent explosive mixtures. In some instances, operation 2315 can include additional and/or alternative steps of controlling flow of the system feed.

Method 2300 can include, as an optional embodiment, operation 2325 to control an inert gas flow through the pyrolysis reactor. As discussed herein, an inert gas flow/purge can be used to purge oxygen-containing chemicals and/or flammable chemicals from the reactor to avoid explosive mixtures. However, as discussed herein, an inert gas purge may not always be necessary. Therefore, in some instances, the system may not always include an inert gas flow and/or may not always feed inert gas through the reactor between phases (e.g., pyrolysis mode and regeneration mode, or vice versa). In instances where the system is purging the reactor, operation 2325 can include flowing the inert gas flow through the pyrolysis reactor between the pyrolysis mode and the regeneration mode and/or between the regeneration mode and the pyrolysis mode, where the inert gas flow purges gas from the pyrolysis reactor.

Method 2300 can include operation 2330 to control movement of the mechanical removal mechanism. As discussed herein, in some instances regeneration may be utilized to not fully remove carbon buildup from the reactor but instead weaken the carbon so it can more effectively be removed through mechanical means. In some embodiments, these mechanical means can include a mechanical removal mechanism, where movement of the mechanism removes at least a portion of the carbon buildup. Therefore, in some embodiments, operation 2330 can include moving the mechanical removal mechanism when the pyrolysis system is in the pyrolysis mode and when the pyrolysis system is in the regeneration mode, as the mechanical removal mechanism can be executed during pyrolysis and/or regeneration. In some embodiments, the mechanical removal mechanism can be the rotating element(s) and/or tube(s) discussed herein. In some embodiments, controlling movement of the mechanical removal mechanism can include rotating the one or more rotating elements/tubes. For example, when a system/reactor includes two rotating tubes (such as tubes 1610 and 1620), controlling movement of the mechanical removal mechanism can include rotating the tubes in opposing and/or counter-rotating directions. In some instances, operation 2330 can include additional and/or alternative steps of controlling flow of the system feed.

Advantages of embodiments disclosed herein include effectively removing carbon buildup from a pyrolysis reactor without complete shut down and/or disassembly and without interruption of hydrogen production, using mechanical removal methods such as rotating element(s); increasing removal effectiveness and preventing system damage by weaking the carbon buildup (through regeneration and/or thermal cycling) so it can be more easily and effectively removed through other removal methods; reducing and/or removing resulting carbon dioxide emissions from regeneration (through shorter durations of regeneration, downstream processing of regeneration product(s), etc.); etc.

To facilitate an understanding of the subject matter described herein, many aspects are described in terms of sequences of actions. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the application. The use of any and all examples, or exemplary language (e.g., “such as”) provided herein, is intended merely to better illustrate the subject matter and does not pose a limitation on the scope of the subject matter. The use of the term “based on” and other like phrases indicating a condition for bringing about a result, both in any claims and in the written description, is not intended to foreclose any other conditions that bring about that result. No language in the specification should be construed as indicating any non-claimed element as essential to the practice any claimed inventions.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of this disclosure. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Thus, embodiments of a pyrolysis system with effective carbon buildup removal are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A pyrolysis reactor configured to generate a product stream from a system feed, wherein the system feed comprises a hydrocarbon reactant, and wherein the product stream comprises hydrogen gas and solid carbon, the reactor comprising:
a rotating element comprising a first surface; and
a second surface spaced apart from the first surface by no more than a predetermined distance, wherein, in operation:
the first surface and/or the second surface is positioned to receive the solid carbon, resulting in carbon buildup on the first surface and/or the second surface, and
as the rotating element rotates, the first surface and/or second surface is configured to remove at least a portion of the carbon buildup.

2. The reactor of claim 1, wherein the rotating element comprises a first rotating element and the pyrolysis reactor further comprises a second rotating element that includes the second surface.

3. The reactor of claim 2, wherein, in operation, the carbon buildup is received on the first surface and the second surface.

4. The reactor of claim 2, wherein the first rotating element and the second rotating element are configured to rotate in a same direction.

5. The reactor of claim 2, wherein the first rotating element and/or the second rotating element is configured to stop rotation and/or reverse a direction of rotation based on at least one of sensor feedback and time intervals.

6. The reactor of claim 2, wherein the first rotating element and the second rotating element have different cross-sectional dimensions.

7. The reactor of claim 2, wherein the first rotating element and the second rotating element have different shapes.

8. The reactor of claim 2, wherein rotation of the first rotating element and the second rotating element cause the carbon buildup to be removed from each of the first surface and the second surface.

9. The reactor of claim 2, wherein the first rotating element and the second rotating element are helical rotating elements.

10. The reactor of claim 1, wherein the predetermined distance is between 0.5 millimeters and 500 millimeters.

11. The reactor of claim 1, wherein the predetermined distance is moveable.

12. The reactor of claim 1, wherein the rotating element is horizontally oriented or is vertically oriented.

13. The reactor of claim 1, further comprising:
a regeneration oxidizer feed, wherein the regeneration oxidizer feed is configured to react with the carbon buildup.

14. The reactor of claim 13, wherein the regeneration oxidizer feed is configured to alter structural properties of the carbon buildup when reacted with the carbon buildup, resulting in a weakened carbon buildup.

15. The reactor of claim 13, wherein the first surface and/or the second surface is configured to remove at least a portion of the carbon buildup remaining after the regeneration oxidizer feed.

16. A pyrolysis system comprising:
a pyrolysis reactor comprising a pyrolysis chamber configured to generate a product stream from a system feed, wherein the system feed comprises a hydrocarbon reactant, and wherein the product stream comprises hydrogen gas and solid carbon;
a regeneration oxidizer feed, wherein the pyrolysis reactor is configured to react a regeneration oxidizer with carbon buildup in the pyrolysis chamber to generate a regeneration product stream that is output from the pyrolysis reactor, and wherein the regeneration oxidizer feed is configured to remove a first portion of the carbon buildup through oxidation; and
a mechanical removal mechanism, wherein the mechanical removal mechanism is configured to remove a second portion of the carbon buildup.

17. The pyrolysis system of claim 16, wherein the regeneration oxidizer alters structural properties of the carbon buildup when reacted with the carbon buildup, resulting in a weakened carbon buildup.

18. The system of claim 17, wherein only one of the system feed and the regeneration oxidizer is configured to be in the pyrolysis reactor at a time.

19. The system of claim 17, wherein the mechanical removal mechanism is configured to operate while the system feed is fed into the pyrolysis chamber and/or while the regeneration oxidizer feed is fed into the pyrolysis chamber.

20. The system of claim 17, wherein the mechanical removal mechanism comprises:
a rotating element comprising a first surface; and
a second surface spaced apart from the first surface, wherein, in operation:
the first surface and/or the second surface is positioned to receive the second portion of the carbon buildup, and
as the rotating element rotates, the first surface and/or second surface is configured to remove at least a portion of the second portion of the carbon buildup.

21. The system of claim 17, further comprising:
an exhaust treatment system downstream from the pyrolysis reactor, wherein the exhaust treatment system is configured to use a reverse regeneration reaction to partially and/or fully decarbonize the regeneration product stream.

22. The system of claim 17, further comprising a heat source, wherein the heat source is configured to cool and/or heat the carbon buildup within the pyrolysis reactor beyond a standard pyrolysis temperature, and then return the carbon buildup to the standard pyrolysis temperature.

23. A pyrolysis reactor configured to generate a product stream from a system feed, wherein the system feed comprises a hydrocarbon reactant, and wherein the product stream comprises hydrogen gas and solid carbon, the reactor comprising:
a first rotating tube comprising an outer surface;
a second rotating tube comprising an inner surface, wherein the first rotating tube and the second rotating tube are coaxial and non-concentric; and
a pyrolysis chamber between the outer surface of the first rotating tube and the inner surface of the second rotating tube, wherein pyrolysis of the system feed is configured to occur in the pyrolysis chamber, wherein, in operation:
the first rotating tube is positioned to receive the solid carbon that deposits on the outer surface and the second rotating tube is positioned to receive the solid carbon that deposits on the inner surface, resulting in carbon buildup on the outer surface and the inner surface, and
rotation of the first rotating tube and the second rotating tube is configured to remove at least a portion of the carbon buildup.

24. The reactor of claim 23, wherein the first rotating tube and the second rotating tube are configured to rotate in opposing and/or counter-rotating directions.

25. The reactor of claim 23, wherein the first rotating tube and/or the second rotating tube is configured to stop rotation and/or reverse a direction of rotation based on at least one of sensor feedback and time intervals.

26. The reactor of claim 23, wherein the pyrolysis chamber is a crescent-shaped volume.

27. The reactor of claim 23, wherein the reactor comprises a heat source configured to heat the first rotating tube and the second rotating tube, wherein:
heating the first rotating tube and the second rotating tube is configured to heat the pyrolysis chamber; and
the first rotating tube and the second rotating tube are configured to transfer heat to the system feed as it flows along a length of the pyrolysis chamber.

28. The reactor of claim 23, wherein the at least the portion of carbon buildup is removed at a narrow gap between the outer surface of the first rotating tube and the inner surface of the second rotating tube.

29. The reactor of claim 23, wherein the first rotating tube and the second rotating tube are inclined at an angle relative to horizontal.

30. The reactor of claim 23, further comprising:
a metal end adapter assembly on each end of the first rotating tube and the second rotating tube, the metal end adapter assembly comprising a metal adapter sleeve and an intermediate annular element.

31. The reactor of claim 30, wherein:
the metal adapter sleeve is positioned concentrically around the first rotating tube and/or the second rotating tube with an annular gap between the metal adapter sleeve and the first rotating tube and/or the second rotating tube; and
the intermediate annular element is positioned in the annular gap.

32. The reactor of claim 23, wherein the first rotating tube and the second rotating tube comprise ceramic tubes comprising at least one of silicon carbide, alumina, mullite, and silicon nitride.

33. The reactor of claim 23, wherein the first rotating tube and the second rotating tube are configured to rotate for an extended period in an inert environment.

34. A method for removing carbon buildup from a pyrolysis system, the method comprising:
providing the pyrolysis system, the pyrolysis system comprising:
a pyrolysis reactor comprising a pyrolysis chamber configured to generate a product stream from a system feed, wherein the system feed comprises a hydrocarbon reactant, and wherein the product stream comprises hydrogen gas and solid carbon, wherein at least a portion of the solid carbon builds up in the pyrolysis reactor, resulting in carbon buildup,
a regeneration oxidizer feed, wherein the regeneration oxidizer feed is configured to react with the carbon buildup, and
a mechanical removal mechanism;
controlling a flow of the system feed through the pyrolysis reactor;
controlling a flow of the regeneration oxidizer feed through the pyrolysis reactor; and
controlling movement of the mechanical removal mechanism, wherein the movement of the mechanical removal mechanism removes at least a portion of the carbon buildup.

35. The method of claim 34, wherein:
controlling the flow of the system feed comprises:
when the pyrolysis system is in a pyrolysis mode, feeding the system feed through the pyrolysis reactor, and
when the pyrolysis system is in a regeneration mode, stopping flow of the system feed through the pyrolysis reactor;
controlling the flow of the regeneration oxidizer feed comprises:
when the pyrolysis system is in the pyrolysis mode, stopping flow of the regeneration oxidizer feed through the pyrolysis reactor, and
when the pyrolysis system is in the regeneration mode, feeding the regeneration oxidizer feed through the pyrolysis reactor; and
controlling the movement of the mechanical removal mechanism comprises:
moving the mechanical removal mechanism when the pyrolysis system is in the pyrolysis mode and/or when the pyrolysis system is in the regeneration mode.

36. The method of claim 35, further comprising:
controlling an inert gas flow through the pyrolysis reactor, wherein controlling the inert gas flow comprises:
flowing the inert gas flow through the pyrolysis reactor between the pyrolysis mode and the regeneration mode and/or between the regeneration mode and the pyrolysis mode, wherein the inert gas flow purges gas from the pyrolysis reactor.

37. The method of claim 34, wherein:
the pyrolysis reactor comprises:
a first rotating tube comprising an outer surface, and
a second rotating tube comprising an inner surface, wherein the pyrolysis chamber is between the outer surface and the inner surface;
the mechanical removal mechanism comprises the first rotating tube and the second rotating tube; and
controlling the movement of the mechanical removal mechanism comprises:
rotating the first rotating tube and the second rotating tube in opposing and/or counter-rotating directions.
